(19) United States
(12) Patent Application Publication
(10) Pub. No.: US 2010/0161472 A1
(43) Pub. Date: Jun. 24, 2010

(54) Methods, apparatus, and systems for clearing a forward capacity auction

(75) Inventors: Tongxin Zheng, Longmeadow, MA (US); Eugene Litvinov, Longmeadow, MA (US)

Correspondence Address: Lipsitz & McAllister, LLC, 755 MAIN STREET, MONROE, CT, 06468, US

(73) Assignee: ISO New England Inc., Holyoke, MA (US)

(21) Appl. No.: 12/317,395

(22) Filed: Dec. 22, 2008

(51) Int. Cl. G06Q 40/00

(52) U.S. Cl. 705/37

(57) ABSTRACT

Methods, apparatus and systems for clearing a forward capacity auction are provided. A limited number of lumpy bids and offers received in the auction are selected. A plurality of feasible price/quantity combinations may then be generated for the selected bids and offers. A minimum consumer payment may be determined from the plurality of feasible price/quantity combinations. A market clearing solution may be obtained based on the minimum consumer payment.

### BACKGROUND OF THE INVENTION

The present invention relates to the field of auction clearing. More specifically, the present invention relates to methods, apparatus, and systems for clearing a forward capacity auction.

The Forward Capacity Auction (FCA) is the primary type of auction used by an Independent System Operator (ISO) or other manager of a bulk electric power market for the procurement of generation capacity in a Forward Capacity Market (FCM) to satisfy the installed capacity requirement for the region. Generating resources (generators, import contracts) and qualified demand response resources can bid into the auction to receive capacity supply obligations, and subsequently get paid the capacity market clearing prices.

The FCA is conducted in the form of a descending clock auction (DCA). Prior to conducting the DCA, existing capacity resources (generators, imports and demand response) submit de-list bids, and new capacity resources submit their projects for qualification review. Once those bids and offers are verified and accepted, participation in the DCA is permitted. The DCA is conducted by announcing a starting clock price for each capacity zone, with subsequent reduction in the price announced at the beginning of each round thereafter to identify the true supply curve of each bidder. Each bidder provides quantities and prices indicative of their willingness to supply. When the price clock ticks down, a bidder cannot increase its bid quantity. The DCA stops when the total supply in the last round is not sufficient to meet the installed capacity requirement. The aim of the DCA is to discover the true supply curve of each bidder. It does not determine the cleared quantity for each bid and the market clearing prices.

After the DCA stops, a market clearing engine is run to calculate the quantity cleared for each bid/offer and the capacity market clearing prices. The market clearing engine uses the supply curve discovered by the DCA for each resource, and the conditions that stop the DCA to clear the market in a least cost fashion.

As described in the Forward Capacity Market (FCM) rules (“ISO New England Section III-Market Rule 1-Standard Market Design Section III.13—Forward Capacity Market” available at http://www.iso-ne.com/regulatory/tariff/sect_{—}3/08-11-7_mr1_sect_{—}13-14_v11a.pdf), the FCA clearing is conducted after the descending clock auction (DCA) stops. The goal of the clearing engine is to clear the capacity market by minimizing the total capacity cost of the commitment period. To be specific, it seeks to solve a consumer payment minimization problem (CPM) for the primary auction, rather than an as-bid cost minimization problem (BCM). Both CPM and BCM are challenging problems when lumpy offers and bids are present.

Given the FCM rules, which allow lumpy offers, the CPM problem is a nonlinear mixed integer mathematical programming problem with equilibrium constraints (MPEC), which is very difficult to solve. No commercial solver has yet been found to handle these complex problems. The associated BCM problem is a mixed integer problem (MIP) with a quadratic objective function, and is relatively easy to solve. BCM, which is equivalent to finding the intersection of the supply and demand curves to meet the installed capacity requirement (ICR) or local sourcing requirements (LSRs), can be used in solving the CPM problem.

In particular, the goal of the CPM is to minimize the total consumer payment for the FCA while satisfying system reliability requirements. Mathematically, it can be described as:

Minimize Total Consumer Payment
Subject to:

Supply Meets Demand (ICR and LSR)
External Interface Limits and MCL Constraints
Equilibrium Conditions for Each Supply Block

Market Clearing Constraints for De-list Bids that are Restricted by the Quantity Rule
Inter-Zonal Market Clearing Price Relationship
Supply Clearing Dependency
Resource Level Constraints

The problem solves for market clearing prices and cleared quantities simultaneously. Nonlinearity is introduced in the objective function due to the presence of market clearing prices, and the non-convexity is present in the constraints due to the lumpy nature of the offers and bids. In addition, complementarity constraints exist in the problem upon the introduction of market clearing conditions. In short, the CPM is a mathematical program with equilibrium constraints (MPEC) problem, which is extremely difficult to solve.

The technique used to solve this problem is the MPEC programming. However, the full problem cannot be solved reliably within a given time frame using any existing commercial software available in the market.

Another challenge of the problem is determining clearing prices for the integer problem. Even under BCM, the determination of prices is not trivial and requires very careful analysis. The definition of the prices should assure incentive compatibility and the ability of the market to reach equilibrium.

It would be advantageous to provide methods, apparatus, and systems for clearing a forward capacity auction that overcome the foregoing problems. It would be further advantageous to provide a solution to the CPM problem that satisfies both regulatory (current settlement agreement and Market Rules) agreements and performance constraints. It would be further advantageous to provide a solution that solves the CPM problem within reasonable time (2-4 hours) using heuristics and a tradeoff between the time and the optimality of the solution.

The methods, apparatus, and systems of the present invention provide the foregoing and other advantages.

### SUMMARY OF THE INVENTION

The present invention relates to methods and apparatus for clearing a forward capacity auction. In one embodiment, a method for clearing a forward capacity auction is provided in which an initial bid cost minimization problem is solved based on bids and offers received in the auction to provide a price-quantity set (Pₒ, Qₒ) that includes zonal price-quantity pairs for each zone that satisfy a market equilibrium condition. It can then be determined if Q₀ is a feasible solution for a consumer payment minimization problem. If Q₀ is a feasible solution, then market clearing post processing for the price-quantity set (Pₒ, Qₒ) may be performed and final clearing results for the auction can be output.

If Q₀ is not a feasible solution, then a benchmark solution for a consumer payment minimization problem can be obtained based on the bids and offers received in the auction. At least one zonal price ceiling may be calculated. A limited number of lumpy offers and price levels may be selected for enumeration. At least one feasible price/quantity combination may be generated for the bids and offers which are based on the selected lumpy offers and price levels and are constrained by the at least one zonal price ceiling. A consumer payment for each of the generated price/quantity combinations may then be calculated. A smallest of the consumer payments may then be compared with a consumer payment calculated for the benchmark solution. If the smallest consumer payment is less than the consumer payment for the benchmark solution, then the benchmark solution may be set to correspond to the smallest consumer payment, and market clearing post processing may be performed for this reset benchmark solution. Final clearing results for the auction may then be output.

The method may further comprise performing market clearing post processing for the benchmark solution.

In a further embodiment of the present invention, the method may also comprise solving a further bid cost minimization problem for each of the generated price/quantity combinations to obtain corresponding solutions to the consumer payment minimization problem. Market clearing post processing for each of the corresponding solutions for the generated price/quantity combinations may be performed to provide corresponding market clearing solutions. Each of the consumer payments may be based on the market clearing solution for the corresponding price/quantity combination.

When solving the initial bid cost minimization problem, all offer curves may be deemed to be rationable. In addition, any interdependency of supply blocks are not considered, and economic minimum and minimum rationing limit constraints of capacity resources are not considered.

A supply curve for each bid may be obtained for use in solving the bid cost minimization problem. The obtaining of the supply curve may comprise applying a quantity rule to each supply block of the bid. The quantity rule may comprise a price cap for each block of a bid. A single-price bid that is subject to the quantity rule may be transformed into a linear price curve. The linear price curve may comprise a straight line which commences at a beginning of the block at a low price limit specified by the quantity rule and terminates at an end of the block at a high price limit specified by the quantity rule.

A demand curve for each demand bid may be obtained for use in solving the bid cost minimization problem. The obtaining of the demand curve may comprise applying a quantity rule to each demand block of the bid. The quantity rule may comprise a price cap for each block of a bid. A single-price bid that is subject to the quantity rule may be transformed into a linear priced rational demand curve. The linear priced rational demand curve may comprise a straight line which commences at a beginning of the block at a high price limit specified by the quantity rule and terminates at an end of the block at a low price limit specified by the quantity rule.

Q₀ may comprise a feasible solution to the consumer minimization problem if all marginal blocks in Q₀ are rational.

In one embodiment of the present invention, the obtaining of the benchmark solution for the consumer payment minimization problem based on the bids and offers received in the auction may comprise, for any lumpy supply offers that are partially cleared in the initial bid cost minimization problem, setting the cleared quantity to a size of the block for supply and to zero for demand. Then, the consumer payment minimization problem may be solved as a second bid cost minimization problem to obtain the benchmark solution.

The calculating of the at least one zonal price ceiling may comprise deriving a price ceiling for each import-constrained zone and a Rest-of-Pool (ROP) zone from P₀ and the benchmark solution. The price ceiling may be used in selecting the limited number of lumpy offers and price levels.

In a further example embodiment, for each import-constrained zone, if a local sourcing requirement constraint is binding, a zonal capacity clearing price for the corresponding import-constrained zone will be higher than a zonal capacity clearing price for the ROP and the price ceiling for the corresponding import-constrained zone will be a highest price that can be achieved based on the benchmark solution by minimizing the consumer payment for the zone and all its attached external interfaces that have the same market clearing price as the price of the import-constrained zone from the initial bid cost minimization solution. If the local sourcing requirements constraint is not binding, the price ceiling for the corresponding import-constrained zone is equal to the zonal capacity clearing price ceiling for the ROP.

The price ceiling for the ROP may be a highest price that can be achieved based on the benchmark solution by minimizing the consumer payment of all zones that have the same market clearing price as an ROP price from the initial bid cost minimization solution.

The at least one zonal price ceiling may further comprise a zonal price ceiling for an export-constrained zone. The price ceiling for the export-constrained zone may be the same as the price ceiling for the ROP.

Market clearing post processing may comprise calculating market clearing prices based on the quantity Q₀ or the quantity from each of the price/quantity combinations. In one example embodiment, the market clearing prices for each zone must be greater than or equal to a highest bid or offer price of all cleared bids or offers in the auction and. the market clearing prices must satisfy price separation conditions among capacity zones and external interfaces.

The market clearing post processing may further comprise clearing of supply and demand side bids restricted by a quantity rule. The clearing of the bids may comprise separately determining a capacity clearing Q for each bid using the price P. The clearing of the supply side bids restricted by the quantity rule may comprise rejecting a bid that has a bid price less than a market clearing price such that capacity corresponding to the bid remains in the market and accepting a bid that has a bid price greater than or equal to the market clearing price such that capacity corresponding to the bid exits the market. Each of the bids restricted by the quantity rule may be considered lumpy such that they are either accepted or rejected in their entirety. The clearing of the demand side bids restricted by the quantity rule may comprise rejecting a bid that has a bid price less than a market clearing price such that capacity corresponding to the bid is not purchased and accepting a bid that has a bid price greater than or equal to the market clearing price such that additional demand is required. Each of the bids restricted by the quantity rule are considered lumpy such that they are either accepted or rejected in their entirety.

The market clearing post processing may further comprise pro-rating tied rationale bids and offers. In such an embodiment, a ratio of an awarded quantity to a size of the bid or offer is equal for all tied bids or offers in the same zone. Further, a total difference between the ratios of any two connected zones that have the same market clearing prices must be in a minimum level.

The selecting of the lumpy offers and price levels may comprise ranking all lumpy offers within each zone by price and removing all lumpy offers having a price higher than a price set by the zonal price ceiling. A price level may be added between any two adjacent lumpy blocks with different offer prices along the ranking. The price level may be set to a higher price of the prices for the two adjacent lumpy blocks. The zonal price ceiling price may be added to the ranking to form a price-block list. The generating of the at least one feasible price/quantity combination may comprise locating a plurality of supply blocks from the price-block list that have a highest offer price cleared in the initial bid cost minimization problem. A priority of the located blocks may be set to a high priority in order of price. The priority of each element in the price-block list may be assigned according to a rank difference between each block and the block with the highest priority, a highest assigned priority corresponding to a smallest difference. A priority level may then be set, starting from the highest priority. An element from the price-block list may then be selected according to its priority to form a price/quantity combination. The priority of the element selected may be great than or equal to the set priority level.

In a further embodiment of the present invention, a method for clearing a forward capacity auction may comprise selecting a limited number of lumpy bids and offers received in the auction. A plurality of feasible price/quantity combinations may then be generated for the selected bids and offers. A minimum consumer payment can then be determined from the feasible price/quantity combinations. A market clearing solution may be generated based on the minimum consumer payment.

The present invention also includes apparatus and systems corresponding to the methods discussed above. In one example embodiment of the present invention, a system for clearing a forward capacity auction is provided. The system includes means for selecting a limited number of lumpy bids and offers received in the auction, means for generating a plurality of feasible price/quantity combinations for the selected bids and offers, means for determining a minimum consumer payment from the feasible price/quantity combinations, and means for obtaining a market clearing solution based on the minimum consumer payment.

### BRIEF DESCRIPTION OF THE DRAWINGS

The present invention will hereinafter be described in conjunction with the appended drawing figures, wherein like reference numerals denote like elements, and:

FIG. 1 shows an example of a system diagram for the forward capacity auction;

FIG. 2 shows an example of how a de-list bid is combined with existing capacity to create an offer curve;

FIG. 3 shows an example of how a de-list bid restricted by a quantity rule is combined with existing capacity to create an offer curve;

FIG. 4 shows an example of how the supply curve is used in the clearing engine;

FIG. 5 shows a hypothetical offer curve for an existing capacity resource;

FIG. 6 shows an example of a feasible region for an offer with a rationing limit;

FIG. 7 shows an example of a demand curve for an export bid;

FIG. 8 shows an example of a demand curve for an export bid restricted by a quantity rule;

FIG. 9 shows an example of market clearing conditions for a lumpy single-price block;

FIG. 10 shows an example of market clearing conditions for a rationable single-price block;

FIG. 11 shows an example of market clearing conditions for a rationable linear-price block;

FIG. 12 shows an example of market clearing conditions for a lumpy single-price demand block;

FIG. 13 shows an example of market clearing conditions for a rationable single-price demand block;

FIG. 14 shows an example of market clearing conditions for a rationable linear-price demand block;

FIG. 15 is a flowchart showing an example embodiment of a method for clearing a forward capacity auction in accordance with the present invention;

FIG. 16 is a flowchart showing a further example embodiment of a method for clearing a forward capacity auction in accordance with the present invention;

FIG. 17 is a block diagram showing an example embodiment of a system for clearing a forward capacity auction in accordance with the present invention; and

FIG. 18 is a block diagram showing an example embodiment of a market clearing engine used in the system of FIG. 17 in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

In order to formulate the market clearing problem, certain assumptions may be made. Examples of such assumptions are described below. It should be appreciated that the assumptions discussed below are provided as examples only and that the market clearing formula may also be formulated with only certain of the following assumptions, additional assumptions, different assumptions, or with modifications to some or all of the following assumptions.

### System Information

System Configuration

The system for the capacity auction may have, for example, capacity zones that include one rest of pool (ROP) zone, and a few external zones. Each internal capacity zone can be unconstrained, import-constrained or export-constrained. Each external zone may be connected to only one internal capacity zone or ROP.

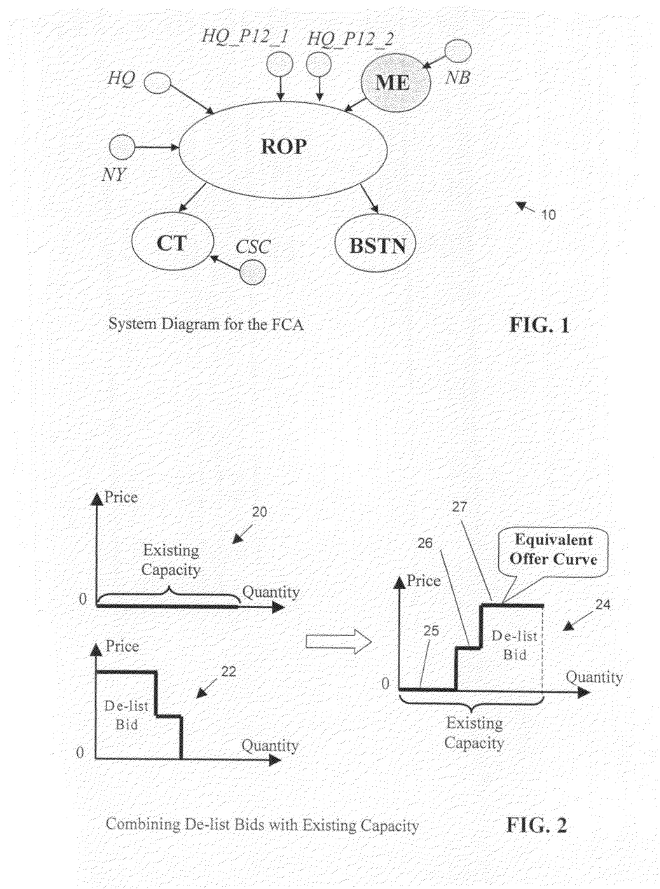

An example system diagram is shown in FIG. 1. In the example shown, the system 10 has a ROP capacity zone, two import-constrained zones (CT and BSTN), one export-constrained zone (ME), and 5 external zones (NY, HQ, NB, HQ_P12_{—}1, HQ_P12_{—}2, and CSC).

Capacity Requirements and Limits

An ICR may be defined for the system as a whole; an LSR may be defined for each import-constrained zone, and a maximum capacity limit (MCL) may be defined for each export-constrained zone; import limit is defined for each external zone.

The ICR will be satisfied by all capacity resources including generators, demands, and imports. The LSR of a capacity zone must be satisfied by the resources located in that zone and those in the external zones that are connected to the capacity zone. The capacity counted to satisfy any of the capacity requirements cannot exceed the MCL and import limits of the external interfaces. In addition, the total amount of capacity from the real-time emergency generation should not exceed the emergency capacity limit (ECL) in satisfying the ICR.

Capacity Resource Types and Locations

Four types of capacity resources may be considered:
Import Contracts
Generators
Demand Response Resources
Real-time Emergency Generation (RTEG)

These capacity resources can be existing or new.

Each resource is located only in one capacity zone, either internal or external. Generators and demands are located in the internal capacity zones, while import contracts are attached to the external zones, which are connected to the internal zones through the external interfaces.

### Offers and Bids

Bid and Offer Types of Capacity Resources

Depending on its qualification, existing resources can bid into the auction using permanent de-list bids, static de-list bids, export bids, administrative export de-list bids and dynamic de-list bids; and new resources can submit offers into the auction.

Table 1 below summarizes the bid types that a resource can submit. In the table, an incremental generator resource can submit offers; however, its offer is tied to its existing capacity resource.

TABLE 1
Resources' Bid Eligibility

| | | Bids/Offers | | | | | |
|---|---|---|---|---|---|---|---|
| | | Bids | | | | | |
| | | Permanent | Static | | Administrative | Dynamic | |
| Rescources | | Delist | Delist | Export | Export | Delist | Offers |
| Existing | Generator | Yes | Yes | Yes | Yes | Yes | No |
| | Import | Yes | Yes | No | No | Yes | No |
| | Demand | Yes | Yes | No | No | Yes | No |
| | Reource | | | | | | |
| | RTEG | Yes | Yes | No | No | Yes | No |
| New | Generator | No | No | No | No | No | Yes |
| | Incremental/ | No | No | No | No | No | Yes, tied |
| | Re-powering | | | | | | to Existing |
| | Generator | | | | | | Capacity |
| | Demand | No | No | No | No | No | Yes |
| | Reource | | | | | | |
| | Import | No | No | No | No | No | Yes |

Bid and Offer Characteristics

Each resource can only submit one bid for each type of bid in the form of price-quantity pairs. Each bid can be either rationable or lumpy.

An existing capacity resource cannot submit a permanent de-list bid in conjunction with either a static or an export de-list bid. However, export and static de-list bids can be submitted together. All de-list bids for existing imports and new import offers may always be considered to be rationable.

Application of the Quantity Rule

Some permanent, static and export de-list bids are subject to the quantity rule. The quantity rule is applied to each block rather than the total bid. The details of the quantity rule are presented in the market rule.

Construction of Equivalent Offer Curve

Treatment of De-list Bids Not Subject to Quantity Rule

Although a de-list bid is in the form of a demand bid, it can be translated into an offer curve by combining with the existing capacity at a zero-dollar price. FIG. 2 shows that a two-block de-list bid for an existing capacity resource is equivalent to a three-block offer. The existing capacity (shown at 20) is combined with the de-list bid (shown at 22) to achieve the offer curve (shown at 24). The first block 25 of the offer curve 24 is a zero-price block with the capacity that equals to the seasonal capacity minus the total amount of de-list bids; the next two blocks 26, 27 are the reverse of the blocks of the de-list bid 22.

Treatment of De-list Bids Subject to Quantity Rule

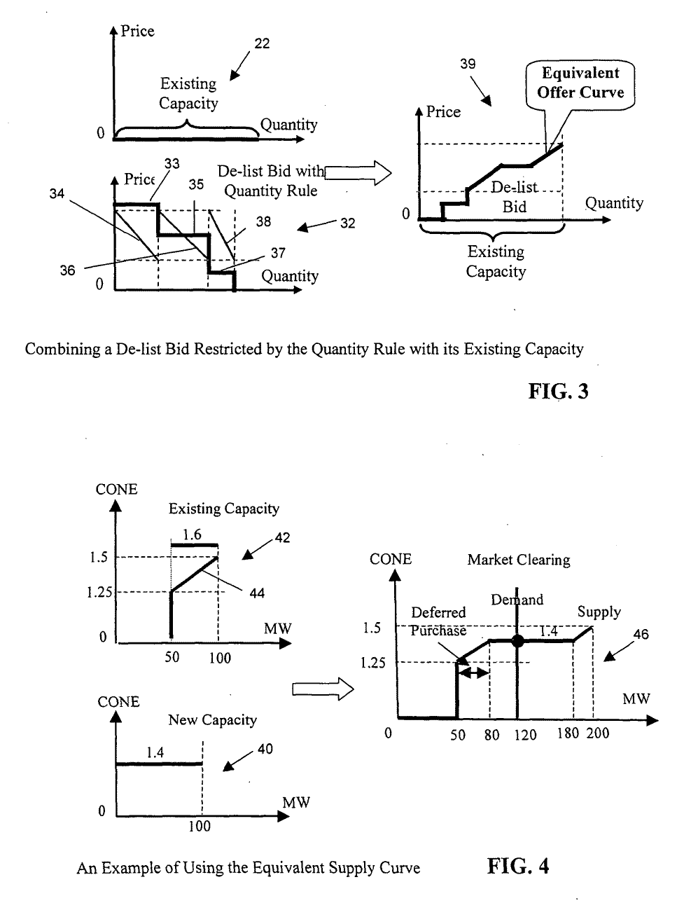

The quantity rule can be treated as a price cap for each bid block for the purpose of market power mitigation. A single-price de-list bid that is subject to the quantity rule will be transformed into a linear price supply curve by a quantity line specified in the quantity rule for use in the market clearing engine. The quantity line starts at the beginning of the block at the high price limit specified in the quantity rule (e.g., 1.5 times the cost of new entry or CONE for permanent de-list bids; 1.2 CONE for the export and static de-list bids), and terminates at the end of the block at the low price limit specified in the quantity rule (e.g., 1.25 CONE for permanent de-list bids; 0.8 CONE for the export and static de-list bids). FIG. 3 shows an existing resource with a three-block de-list bid 32. The first block 33 is completely above the quantity line 34, and the bid will be replaced by the entire quantity line 34. The second block 35 crosses the quantity line 36, and the portion above the quantity line 36 will be capped by the quantity line 36. The third block 37 is completely below the quantity line 38, and therefore, it will be unchanged. The resultant supply offer curve 39 is also shown in FIG. 3.

The offer curve 39 shown in FIG. 3 represents an example of an offer curve for an existing capacity resource with some blocks of its de-list bids capped by the quantity rule. The total quantity cleared on this supply curve is used to satisfy the ICR or LSR requirements, however the total quantity eligible for payment in the FCA is different from what is cleared from the equivalent supply curve due to the quantity rule. If a de-list bid is restricted by the quantity rule, the amount cleared for the equivalent block is the amount of deferred purchase in the FCA. The quantity to be settled in the FCA will be the amount cleared in the equivalent offer curve minus the amount cleared in the quantity-rule-restricted de-list bid.

Note that the export de-list bids are treated differently than the static de-list bids in the application of the quantity rule.

In order to further illustrate the use of the equivalent supply curve in the clearing engine, an example is provided below and illustrated in FIG. 4.

In this example, the ICR is 120 MW. There are two resources in the FCA: one is a new rationable resource 40 offering 100 MW at a price of 1.4 CONE/MW; the other is an existing capacity resource 42 with 100 MW capacity. The existing capacity resource 42 submitted a permanent de-list bid of 50 MW at a price of 1.6 CONE/MW before the DCA. Since the permanent de-list bid is subject to the quantity rule, an equivalent supply curve 44 is built for the existing resource 42. The supply curve of the new capacity resource 40 is equal to its bid. The supply curves for both resources 40, 42 are aggregated to obtain an aggregated supply curve 46. With a vertical demand curve (ICR), the market clears at 1.4 CONE.

As can be seen from the supply curve 46, the cleared quantity for the new offer is 40 MW. The cleared quantity for the existing capacity from the equivalent supply curve is 80 MW. At the given clearing price of 1.4 CONE, the de-list bid of the existing capacity 42 should be cleared, leaving 50 MW of the total capacity obligation for the existing capacity resource 42. The additional 30 MW cleared from the equivalent supply curve for the existing capacity resource is actually the deferred purchase in the primary FCA. In the end, the total capacity obligation from both existing and new resources is 50+40 or 90 MW, the total deferred purchase is 30 MW. The total consumer payment in this example is 90*1.4 or 126 CONE.

Characteristics of the Equivalent Supply Curve

After the final round of the DCA, each capacity resource will have an equivalent non-decreasing supply curve.

This supply curve is built by combining the de-list bids (permanent, static, certain export, dynamic) with existing or new capacity. Each block of the supply curve can be one of the following:
Lumpy Single-price Block;
Rationable Single-price Block;
Rationable Linear-price Block;

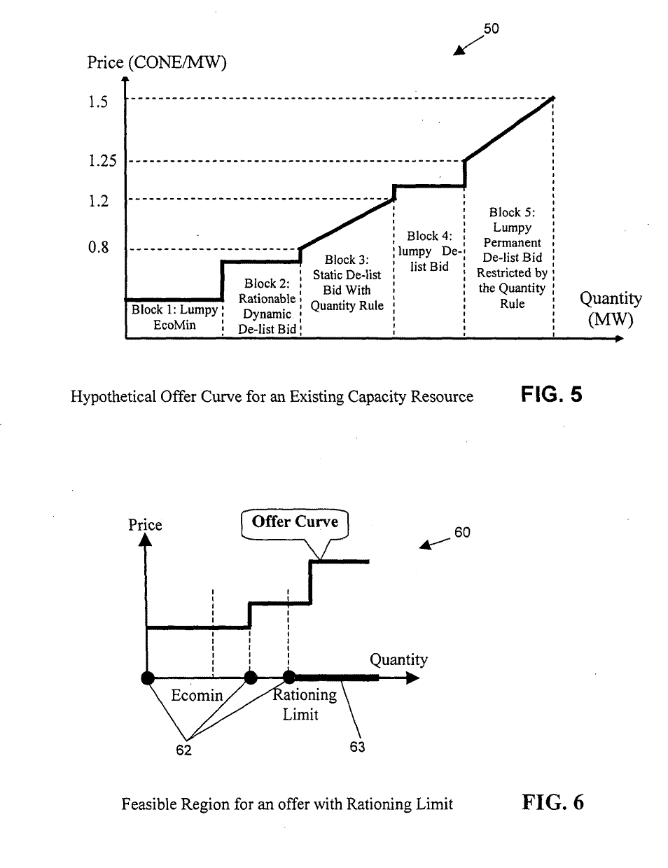

FIG. 5 shows a hypothetical offer curve 50 obtained from DCA. The first block (Block 1) can be considered as a lumpy single-price block, since it requires that the block is taken either as a whole or nothing is taken. This interpretation can be used to model the economic minimum or the lumpy permanent de-list bid below 1.25 CONE. The second block (Block 2) is a single-price rationable block, which is used to represent a dynamic de-list bid. The third block (Block 3) is a rationable linear-price block, which represents a lumpy de-list bid (static de-list) that is restricted by the quantity rule. A rationable block can be cleared below the quantity that maximizes the as-bid profit in a perfectly competitive market. The fourth block (Block 4) is a lumpy single-price block (permanent de-list bid under 1.25 CONE). Block 5 is a rationable linear-price block, which is used to represent a lumpy de-list bid that is restricted by the quantity rule.

Summary of BCM Supply Blocks

Summaries of the adopted types of supply blocks are presented in this section. Table 2 below summarizes the types of offer blocks that are used in the BCM problem.

TABLE 2
Conversion of Bids and Offers to Equivalent Supply Curve in BCM

| | | Types of Equivalent Blocks | | |
|---|---|---|---|---|
| | | Lumpy | Rationable | |
| | | Single- | Single- | Rationable |
| | | Price | Price | Linear-Price |
| Bids and Offers | | Block | Block | Block |
| Lumpy | De-list bids restricted | | | Yes |
| | by the quantity rule | | | |
| | De-list bids that are not | Yes | | |
| | restricted by the | | | |
| | quantity rule | | | |
| | Offer | Yes | | |
| Rationable | De-list bids restricted | | | Yes |
| | by the quantity rule | | | |
| | De-list bids that are not | | Yes | |
| | restricted by the | | | |
| | quantity rule | | | |
| | Offer | | Yes | |

Bid/Offer Parameters

Each capacity resource may specify an economic minimum (EcoMin), minimum rationing limit (MRL) and self-supply amount in their bids. The following assumptions may be made for each type of resource.
An existing generating resource is eligible to specify the EcoMin, and the self-supply amount only.
A new generating resource is eligible to specify the EcoMin (if lumpy), the MRL (if rationable), and the self-supply amount only.
The EcoMin, the MRL, and the self-supply amount of an import resource are always zero.
The Self-supply amount and EcoMin of a resource shall never exceed the size of its first bid/offer block.

Economic Minimum

The economic minimum is modeled as one single lumpy block, and all other supply blocks of the same resource cannot be awarded before the economic minimum block. The MW quantity for an offer/bid at its minimum price must be higher than or equal to its EcoMin.
If the resource is lumpy, its EcoMin must be lower than or equal to the quantity of the first offer/bid block. The EcoMin does not have any effect on the market clearing.
If the resource is rationable, the offer could be lumpy at EcoMin depending on the value of the rationing limit and the size of its first bid/offer block.

Minimum Rationing Limit

The minimum rationing limit must be higher than or equal to the economic minimum. It is only applicable when a resource is new and its offers are rationable.
The offer below the minimum rationing limit is considered to be lumpy. For example, a resource bids in 100 MW at 1.0 CONE, its EcoMin is 70 MW, and its rationing limit is 70 MW. Its clearing quantity can be 0 MW or 70˜100 MW.
The rationing limit is not available to the existing capacity resource.

A Clearing Example

FIG. 6 illustrates a curve 60 of the possible quantities that an offer can clear in the FCA. The dots 62 and line 63 represent the feasibility region for the offer. It shows that the offer can be cleared at 0, blocks above EcoMin and the Rationing Limit, or any value above the rationing limit. The blocks above the rationing limit cannot be cleared when any of the blocks below the rationing limit are not cleared.

Export Bids

A capacity resource can submit an export de-list bid over an external interface. For example, a capacity resource of 400 MW in ME submits a 150 MW export de-list at 1.0 CONE over the CSC interface. The export de-list bid could be considered as a price-sensitive demand in the internal capacity zone to which its external interface is connected (CT in the example). The following assumptions may be made to support the design of the clearing engine.
If an export is submitted for the interface that is attached to the same capacity zone where its capacity resource is located, it will be combined with its existing capacity resource as a capacity supply offer. The clearing of such an export bid will be the same as that of a static de-list bid.
If the export bid is submitted for the external interface that is attached to ROP (and its physical resource is located in an import-constrained zone) or to an export-constrained zone, it will be considered as a static de-list bid at the zone where its physical resource is located.
All other export bids will be considered as a price-sensitive demand in the zones to which their external interfaces are attached. Such bids may also be subject to the following clearing assumptions:
   The export bid is cleared according to the capacity clearing price of the internal capacity zone to which its external interface is connected. Its clearing is not determined by the clearing price of the zone where its capacity resource is located. In this example, the export bid is cleared at the CT clearing price.
   The capacity resource of the export bid will be cleared at its zonal clearing price. If there is no other de-list bid submitted against this resource, its cleared capacity will be the same as its qualified capacity. In the example, the resource is cleared at the ME price, and awarded 400 MW. However, its capacity obligation will be reduced by its cleared export bid.
   The capacity resource will be paid its zonal capacity clearing price and get charged its demand purchase at the zone where the export's external interface is connected. In the example, 400 MW will be paid at the ME price, and 150 MW (if the export is cleared) will be charged at the CT price.
   If an export bid is considered as a price-sensitive demand for that zone, the de-list bid will be translated into a demand curve, and its clearing condition is specified in detail below. The clearing of such demand curve is independent of the supply curve of the physical resource against which the export bid is submitted.
The administrative export de-list bid is always considered as a demand, and is not subject to the quantity rule.

The Equivalent Demand Curve for the Export Bid

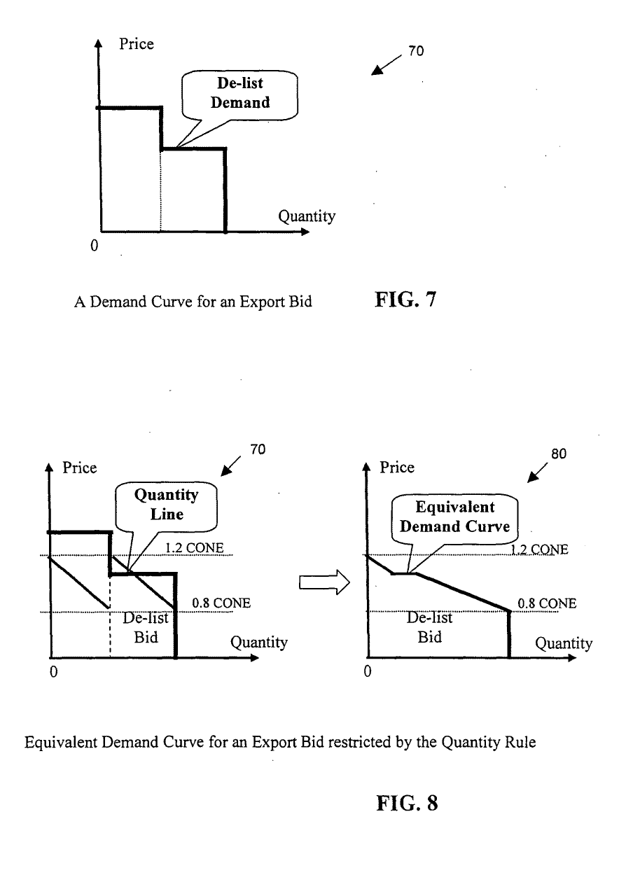

The export bid submitted to a different capacity zone from where its physical resource is located is considered as a demand. FIG. 7 shows such de-list bid considered as a demand curve 70. This curve must be monotonically decreasing.

Certain export de-list bid at an import-constrained zone or ROP will be restricted by the quantity rule. FIG. 8 shows that such an export bid 70 can be translated into a linear-priced rationable demand curve 80. Market clearing is performed on the equivalent demand curve 80.

Similar to the equivalent supply curve, the equivalent demand curve can have three different types of blocks. They are
Lumpy Single-price Block;
Rationable Single-price Block;
Rationable Linear-price Block;

Table 3 below summarizes the conversion from export bids to the equivalent demand curve.

TABLE 3
Conversion of Export De-list Bids to Equivalent Demand
Curve in BCM

| | | Types of Equivalent Blocks | | |
|---|---|---|---|---|
| | | Equivalent Demand Curve | | |
| | | Lumpy | Rationable | |
| | | Single- | Single- | Rationable |
| | | Price | Price | Linear-Price |
| Dids and Offers | | Block | Block | Block |
| Lumpy | Administrative Export | Yes | | |
| | Demand-side Export de- | | | Yes |
| | list bids | | | |
| Rationable | Administrative Export | | Yes | |
| | Demand-side Export de- | | | Yes |
| | list bids | | | |

Note that the demand-side export bid in Table 3 is the one submitted for the interface that is attached to an import-constrained zone from a resource located in a different capacity zone, or for the interface that is attached to ROP from a resource located in an export-constrained zone.

Real-Time Emergency Generation

RTEG resources are special types of capacity resources that can be only called on under the emergency condition in the real-time operation. Thus, they only fulfill the obligation of a capacity resource under such conditions. Different from other capacity resources, they are not required to bid into the day-ahead energy market. Due to such characteristics, special limits are placed on these resources.
All RTEG resources are considered as existing capacity resources in the FCA.
Only permanent, static and dynamic de-list bids can be submitted for RTEG resources.
No de-list bids from RTEG resources are restricted by the quantity rule.
The total amount capacity from RTEG resources counted to meet ICR cannot exceed the ECL.
The total capacity counted to meet LSR or ICR from RTEG resources in a capacity zone shall not exceed the proportion of the zonal total RTEG capacity remained in the last-round of DCA to the total RTEG capacity remaining in the last round pool-wide. In the case of no RTEG capacity remained in any zone in the last round of DCA, the zonal RTEG capacity limit is calculated based on the total RTEG capacity offered at the starting price of the DCA.
The total capacity obligation assigned to the RTEG resources in a zone may exceed its zonal RTEG capacity limit; however, its capacity obligation will be paid at its zonal capacity clearing price with a discount rate, which equals to the RTEG capacity limit divided by the total capacity obligation cleared from all RTEG resources.

### Market Clearing Rules and Conditions

End-of-Round Condition

The market clearing status at the end-of-round price of the last round of the DCA should be available.

The offers available at the end-of-round price of the last round of DCA must be cleared in the FCA.

Supply-Side De-List Bids Clearing

Supply-side de-list bids include the following:
Permanent de-list bids
Static de-list bids
Dynamic de-list bids
Export bids that are submitted to the same capacity zone as the corresponding physical resources
Export bids submitted for the interface attached to ROP from a resource located in an import-constrained zone, or an interface attached to an export-constrained zone.

Market clearing conditions for those de-list bids that are restricted by the quantity rule must be included. These conditions are used in determining quantities that will be paid in the FCA. The following rules are used to clear those de-list bids.

De-List Bids not Restricted by the Quantity Rule

The clearing of those de-list bids will be the same as that of a new offer. That is
The de-list bid can be either rejected (capacity stays) or cleared (capacity is removed) partially (if rationable) and completely (if lumpy) if the market clearing price is higher than or equal to its bid price.
The de-list bid will be fully cleared (the capacity is removed) if the market clearing price is less than its bid price.

De-List Bids Subject to the Quantity Rule

The clearing of these de-list bids will be different from the treatment of a new offer. The following rules may be adopted:
When the market clearing price is higher than or equal to the bid price of a de-list bid, the corresponding de-list bid will be rejected in the auction, i.e. the corresponding capacity will stay in the market;
When the market clearing price is lower than the bid price of a de-list bid, the corresponding de-list bid will be accepted in the auction, i.e. the corresponding capacity will exit the market.
Each de-list bid that is restricted by the quantity rule is considered lumpy. It will be cleared either all or nothing.

Demand-Side De-List Bids Clearing

Demand-side de-list bids include the following:
Administrative Export
Export bids that are submitted to different capacity zones from where their physical resources are located. The export must originate from ROP, other import-constrained zone, or an export-constrained zone for exit at an import-constrained zone, or from an export-constrained zone to ROP.

Market clearing conditions for those de-list bids that are restricted by the quantity rule must be included. These conditions are used in determining quantities that will be charged in the FCA. The following rules are used to clear those de-list bids.

Demand-Side De-List Bids not Restricted by the Quantity Rule

The following demand-side de-list bids are not restricted by the quantity rule:
Administrative Export

The clearing of those de-list bids requires the following:
The de-list bid can be either rejected (zero purchase) or cleared (additional purchase) partially (if rationable) and completely (if lumpy) if the market clearing price is less than or equal to its bid price.
The de-list bid will be fully rejected if the market clearing price is higher than its bid price.

Demand-Side De-List Bids Subject to the Quantity Rule

The demand-side export de-list bids will be restricted by the quantity rule. The clearing of these de-list bids will be the same as static de-list bids restricted by the quantity rule.
When the market clearing price is higher than or equal to the bid price of a de-list bid, the corresponding de-list bid will be rejected in the auction, i.e. there is no additional capacity purchase;
When the market clearing price is lower than the bid price of a de-list bid, the corresponding de-list bid will be accepted in the auction, i.e. additional demand is required.
Each de-list bid that is restricted by the quantity rule is considered lumpy. It will be cleared either all or nothing.

Market Clearing Conditions for the Equivalent Supply Curve

The following describes the market clearing condition or the clearing price-quantity relationship for each type of block defined for the equivalent supply curve.
Lumpy Single-Price Block

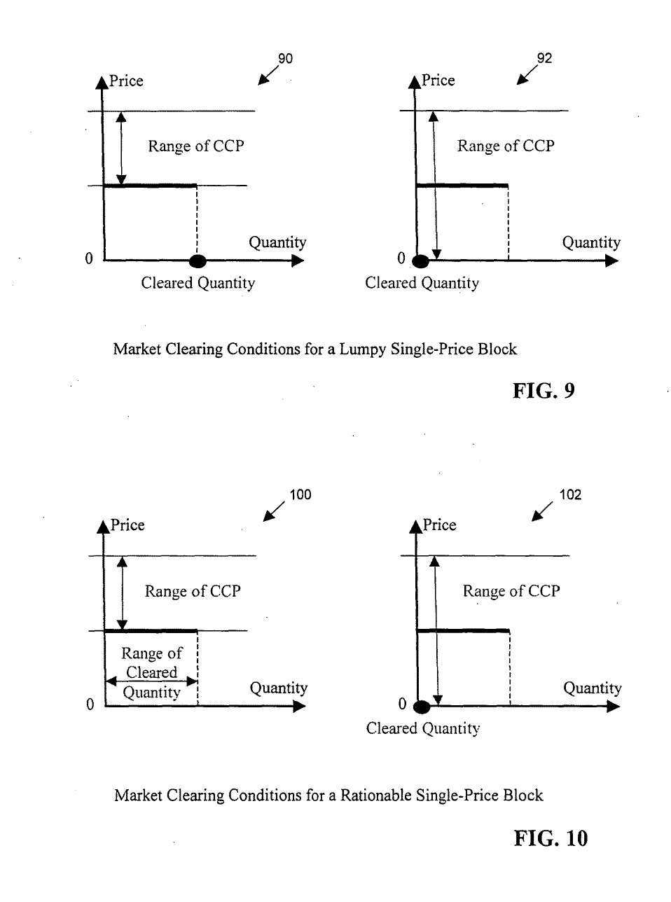

FIG. 9 shows a graphical representation of the market clearing condition for a lumpy single-price block. As shown in FIG. 9, a lumpy single-price block requires the following:
If the block is selected, the cleared quantity equals the block size, and the Capacity Market Clearing Price (CCP) must be at least the value of its bid price (as shown at curve 90).
If the block is not selected, the cleared quantity is zero, and the CCP can be of any value (as shown at curve 92).
Rationable Single-Price Block

FIG. 10 shows a graphical representation of the market clearing condition for a rationable single-price block. As shown in FIG. 10, a rationable single-price block requires the following:
When the CCP is higher than or equal to the offer price, the cleared quantity can be any value between zero and the block size (as shown at curve 100).
If the CCP is below the offer price, the cleared quantity is zero (as shown at curve 102).
Rationable Linear-Price Block

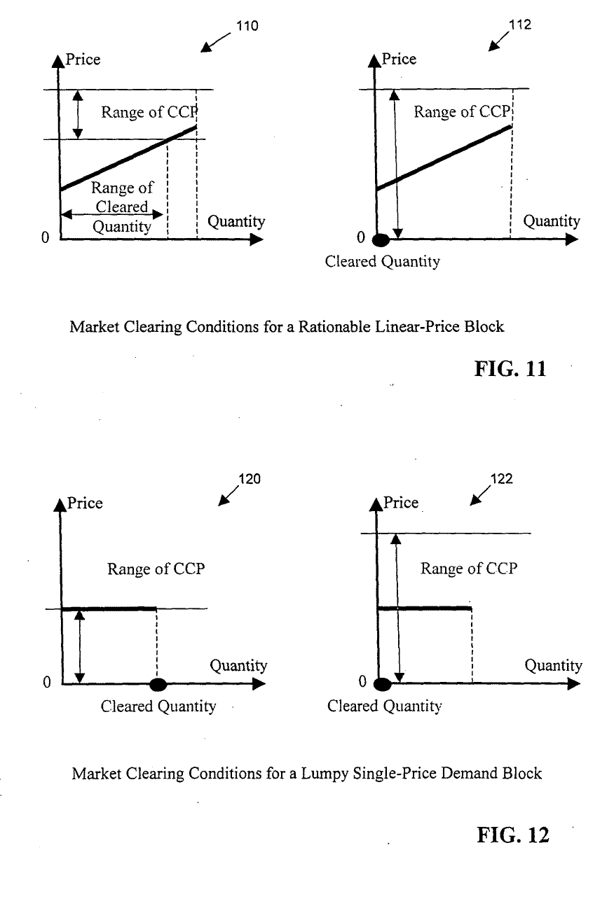

FIG. 11 shows a graphical representation of the market clearing condition for a rationable linear-price block. As shown in FIG. 11, a rationable linear-price block requires the following:
When the CCP is higher than or equal to the minimum offer price, the cleared quantity can be any value between zero and the quantity where it can achieve the maximum as-bid profit (as shown at curve 110).
If the CCP is below the minimum offer price, the cleared quantity is zero (as shown at curve 112).

Note that in the bid-cost minimization, the assumption may be made that the equivalent offer curve for de-list bids that are restricted by the quantity rule is a rationable linear-price curve.

Market Clearing Conditions for the Equivalent Demand Curve

The following describes the market clearing condition or the clearing price-quantity relationship for each type of block defined for the equivalent demand curve.
Lumpy Single-Price Demand Block

FIG. 12 shows a graphical representation of the market clearing condition for a lumpy single-price block. As shown in FIG. 12, a lumpy single-price block requires the following:
If the block is selected, the cleared quantity equals the block size, and the CCP must be no greater than the value of its bid price (as shown at curve 120).
If the block is not selected, the cleared quantity is zero, and the CCP can be any value (as shown at curve 122).
Rationable Single-Price Demand Block

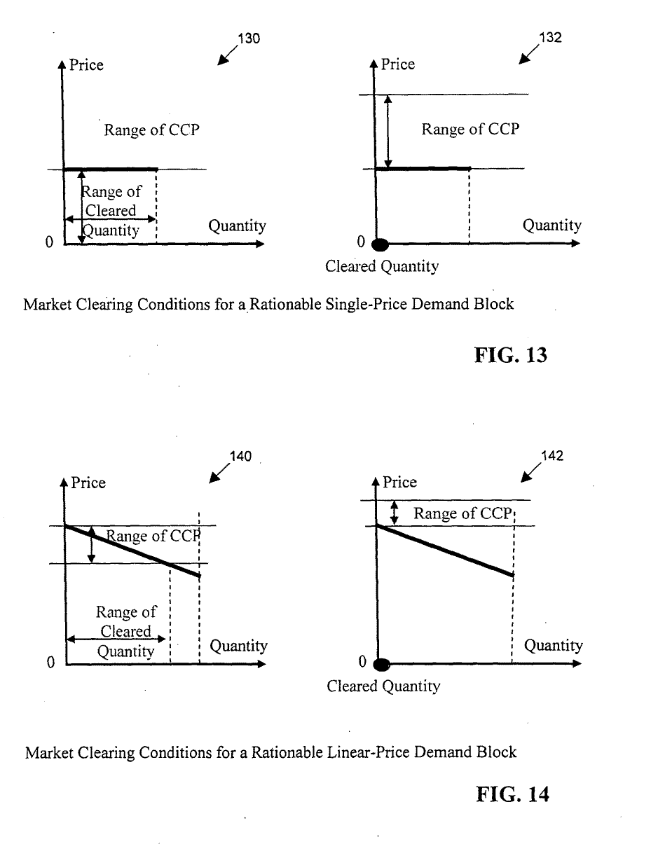

FIG. 13 shows a graphical representation of the market clearing condition for a rationable single-price block. As shown in FIG. 13, a rationable single-price demand block requires the following:
When the CCP is lower than or equal to the bid price, the cleared quantity can be any value between 0 and the size of the block (as shown at curve 130).
If the CCP is above the bid price, the cleared quantity is 0 (as shown at curve 132).
Rationable Linear-Price Demand Block

FIG. 14 shows a graphical representation of the market clearing condition for a rationable linear-price block. As shown in FIG. 14, a rationable linear-price demand block requires the following:
When the CCP is lower than or equal to the maximum bid price, the cleared quantity can be any value between zero and the quantity where it can achieve the maximum as-bid utility (as shown at curve 140).
If the CCP is higher than the maximum of the bid price, the cleared quantity is zero (as shown at curve 142).

Note that in the bid-cost minimization, the assumption may be made that the equivalent demand curve for an export bid that is restricted by the quantity rule is a rationable linear-price curve.

Supply and Demand Clearing Dependency

Market clearing dependencies are enforced for each individual supply curve. The higher priced block cannot clear without clearing the full amount of the lower-priced blocks. The condition holds no matter what kind of characteristics the lower-priced blocks have.

Market clearing dependencies are enforced for each individual demand curve. The lower priced block cannot clear without clearing the full amount of the higher-priced blocks. The condition holds independent of the characteristics of the higher-priced blocks.

Capacity Market Clearing Price Determination

Each internal and external (interface) capacity zone has a capacity market clearing price.

The Capacity Market Clearing Price (CCP) for each capacity zone will be determined based on the highest cleared capacity offers in that zone, while satisfying the price relationship between capacity zones. The details may be described as follows.
The capacity clearing price for each capacity zone will be at least the highest cleared capacity offer in that zone.
The capacity clearing price for each capacity zone will be at most the lowest price of the cleared demand bid in that zone.
If there is no price separation between an import-constrained zone and ROP in the initial BCM (assuming all offers are rationable), there will be no price separation between these two zones in the final solution.
The capacity clearing price of an import-constrained zone must be the same as that of ROP, if the LSR can be met when the smallest cleared capacity offer is rejected. Such capacity shall not include any capacity cleared at the end-of-round price of the last round for the zone.
The capacity clearing price of an export-constrained zone must be the same as that of ROP if the total cleared capacity in the zone and its external interface (subject to the import limit) is below its MCL and satisfy one of the following conditions:
   There is at least one un-cleared offer with price lower than or equal to the clearing price of ROP, its smallest amount of capacity that can be cleared is less than or equals to the difference between MCL and the total cleared quantity in that export-constrained zone (including its external zone).
   There is no uncleared offer with price lower than or equal to the clearing price of ROP.

Otherwise, a price separation occurs between an export-constrained zone and ROP
The capacity clearing price is determined by the capacity offers and partially cleared bids that are treated as demand. The capacity clearing price for a zone shall not exceed the lowest price of all cleared demand in the zone.
The capacity clearing prices for all zones and interfaces satisfy the following relationship:
   if the clearing price of an external zone is higher than the price of the zone it is attached to, the price of the zone it is attached to will be set the same as the price of the external zone;
   if the clearing price of an export-constrained capacity zone is higher than the price of ROP, the price of the ROP will be set the same as the capacity clearing price of the export-constrained zone; and
   If the clearing price of an import-constrained capacity zone is lower than the price of ROP, the price of the import constrained capacity zone will be set the same as the price of ROP.

Note that the offer prices used in the CCP determination are the offer prices of the equivalent offers. These rules may be used in the enumeration process for each feasible solution in searching for the least cost solution for the CPM.

Pricing Under Inadequate Supply

There may be a system-wide or zonal level “inadequate supply” condition in the FCA. The market clearing engine will perform the following tasks under such conditions.
Under the system-wide inadequate supply condition, all capacities in the import-constrained zones and ROP will be cleared at a price of 2 times of CONE for each zone. A separate capacity clearing price can be derived for an export-constrained zone if there are more capacity than its MCL.
Under the zonal inadequate supply conditions, the price for the zone with inadequate supply will be 2 times of CONE of the zone. At that price, all capacities must be cleared. Furthermore, the capacity clearing price for other zones must be determined.
In the case of inadequate supply, all the de-list bids with price 2.0 CONE will be cleared (i.e., the capacity is removed.)

Capacity Price Floor

The lowest possible price for a capacity zone is 0.6 CONE. At that price floor, there may be enough available capacity remaining to meet ICR or LSR. The market clearing engine will perform the following:
If the external interface ends up with excess capacity (more than its import limit), its price will be 0.6 CONE. The price for the rest of the zones will be determined by the market clearing engine.
If the export-constrained zone ends up with excess capacity (more than its MCL), its zonal price and the price of its external interface will be set to 0.6 CONE. Other zonal prices will be determined by the clearing engine.
If the system ends up with the excess capacity (more than ICR), the price for ROP, that of its external interface, and that of the export constrained zone will be 0.6 CONE. The price of the import constrained zone will be calculated by the clearing engine.
If an import-constrained zone ends up with excess capacity (more than LSR at the floor price 0.6 CONE), all prices except other import-constrained zones that are not under this condition and their external interfaces will be set to 0.6 CONE.

Tie-Breaking Rule

The following tie-breaking rule will be implemented in the FCA clearing engine.
When the total procurement cost of two solutions is the same, the clearing result will be the one that has the higher total amount of procured capacity.
If the total amount of the cleared capacity is the same, the outcome with the lower total as-bid cost will be selected.
If offers are tied and all are rationable, each offer will be cleared proportionally based on its block size.
If offers are still tied, the market clearing will be based on the market share determined by the end-of-round quantity produced by the DCA. The offers with the lower market share will be cleared first.
In the event the above rules do not break the tie, return all tied outcomes.

Zonal Price Ceiling

A zonal price ceiling for each import-constrained zone may be introduced to remove a potential high price block from the enumeration list. Since the FCA clearing engine seeks to select a minimum consumer payment solution while maintaining a relatively efficient resource allocation among different zones (not driving up price in an import constrained zone too much), the search space could be limited by introducing a price ceiling for each zone (import-constrained zone and ROP). The price ceiling of each zone is the highest price of the zone if only the consumer payment for the zone is minimized. Any offer that is higher than the ceiling price is deemed not to be awarded. The detailed implementation for the price ceiling is presented below.

Terms and Definitions

Terms used herein are defined as follows:

Lumpy refers to the discrete nature of the supply. It means that a bid/offer block can be cleared as a whole or not at all.

Rationing refers to the continuity nature of the bid/offer curve. A rationing block can be cleared partially.

Tie-breaking refers to the market clearing under the condition when multiple solutions that result in the same objective value.

Prorating refers to the market clearing condition where two or more bids have the same bid price.

Nomenclature

Zₗ is the set containing all the import-constrained capacity zones.

Z_{E} is the set containing all the export-constrained capacity zones. s represents the ROP zone.

Z={s}∪Zₗ∪Z_{E} is the set containing all the internal capacity zones.

E is the set containing all the external zones.

E_{z} is the set of external zones that are connected to the capacity zone z ∈ Z.

R is the set containing all capacity resources including both supply-side (capacity resource) and demand-side resources (export de-list bids).

αᵣ indicates whether resource r is a supply-side (1) or a demand-side (−1) resource.

R_{z} is the set containing all capacity resources including RTEG resources located in zone z ∈ Z.

R_{z}^{RT} is the set containing RTEG capacity resources located in zone z ∈ Z.

R_{z}^{N} is the set containing all non-RTEG capacity resources located in zone z ∈ Z, and R_{z}=R_{z}^{N}∪ R_{z}^{RT}.

ECL_{z} is the RTEG capacity limit for zone z.

Rₑ is the set containing capacity resources located in external zone e ∈ E.

Bᵣ is the set containing all equivalent supply blocks of resource r ∈ R, and Bᵣ=Bᵣ^{LS}∪ Bᵣ^{RG}.

Bᵣ^{LS} is the set containing all lumpy single-price supply blocks of resource r ∈ R.

Bᵣ^{RG} is the set containing all rationable (both single-price and linear-price) supply blocks of resource r ∈ R.

Bᵣ^{QRE} is a subset of Bᵣ and includes all equivalent supply blocks that are derived from the quantity rule for resource r ∈ R.

Bᵣ^{QRD} is the set containing all de-list bids that are restricted by the quantity rule for resource r ∈ R (any permanent de-list bid with price at least 1.25 CONE and static and certain export bids). Thus Bᵣ^{QRD} ∩Bᵣ=φ.

Bₚᵣ is the set containing all supply block pairs that have the same offer price. That is Bₚᵣ={(r,r′,b,b′)|b ∈ Bᵣ^{RG} and b ∈ B_{r′}^{RG} and p_{b}^{r}(·)=c_{b}^{r}=p_{b′}^{r′}(·)=c_{b′}^{r′}}.

LSR_{z} is the local sourcing requirement for an import-constrained zone z ∈ Zₗ.

MCL_{z} is the local maximum capacity limit for an export-constrained zone z ∈ Z_{E}.

ICR is the installed capacity requirement for the system.

Iₑ^{max} is the import limit from an external zone e ∈ E.

CCPₑ is the capacity market clearing price for an external zone e ∈ E.

CCP_{z} is the capacity market clearing price for a capacity zone z ∈ Z.

EQ_{z} is the effective supply from non-RTEG resources in zone z or interface e,

EQ_{z}^{RT} is the effective supply from RTEG resources in zone z,

q_{b}^{r} is the quantity cleared from the price curve of resource r ∈ R for block b ∈ Bᵣ.

p_{b}^{r}(·) is the price function of resource r ∈ R for block b ∈ Bᵣ. It must be monotonically increasing for a supply-side resource, and monotonically decreasing from for a demand-side resource.

c_{b}^{r} is the constant price of resource r ∈ R for block b ∈ Bᵣ.

q̅_{b}^{r} is the maximum quantity of block b ∈ Bᵣ for resource r ∈ R.

q^{r} is the total quantity cleared from the equivalent supply curve of resource r ∈ R. This value includes the deferred purchase. The value for a demand-side resource will be negative.

sq^{r} is the total settlement quantity cleared in the FCA of resource r ∈ R. This is the quantity to be paid in the FCA.

EORP_{z}^{o} is the end-of-round price of the last round for zone z ∈ Z.

qₒ^{r} is the quantity determined in the last round at the end-of-round price for resource r ∈ R.

u_{b}^{r} is an integer variable that indicates whether the supply of resource r ∈ R for block b ∈ Bᵣ is cleared. In general, when the cleared quantity is zero, it will be 0; when the cleared quantity is non-zero, it will be 1.

s_{z} is the slack variable that indicates the amount of capacity shortage for zone z.

sₛ is the slack variable that indicates the amount of capacity shortage for the system.

MSᵣ is the pre-determined market share for a resource r,

ε is a very small positive value.

M is a very big positive number.

TCP is the total consumer payment in the objective function.

TPC is the total penalty cost in the objective function.

TBC is the total bid cost.

TPC_{tb} is the total penalty cost for tie-breaking.

TPCₒ is the penalty cost for optimality.

TPC_{f} is the penalty cost of the supply shortage. pc_{f}^{z} is the supply shortage penalty for zone z; it can be set to 2 times of CONE of the zone.

pc_{f}^{s} is the supply shortage penalty of the system; it can be set to 2 times CONE of ROP.

pcₚₛ is a negative price-setting penalty, and pcₚₛ≧pc_{tb}.

pc_{tb} is a positive tie-breaking penalty price.

Based on the foregoing example assumptions, methods, apparatus, and systems for clearing a FCA have been developed in accordance with the present invention.

With the present invention, heuristics are used for the CPM problem.

Heuristic Consumer Payment Minimization (CPM)

The present invention starts from a feasible solution of the CPM and selects certain lumpy bids/offers for evaluation across all zones at the same time. The enumeration is performed system-wide, and the market clearing is performed so as to minimize the overall consumer payment for the whole system, subject to constraints for each capacity zone.

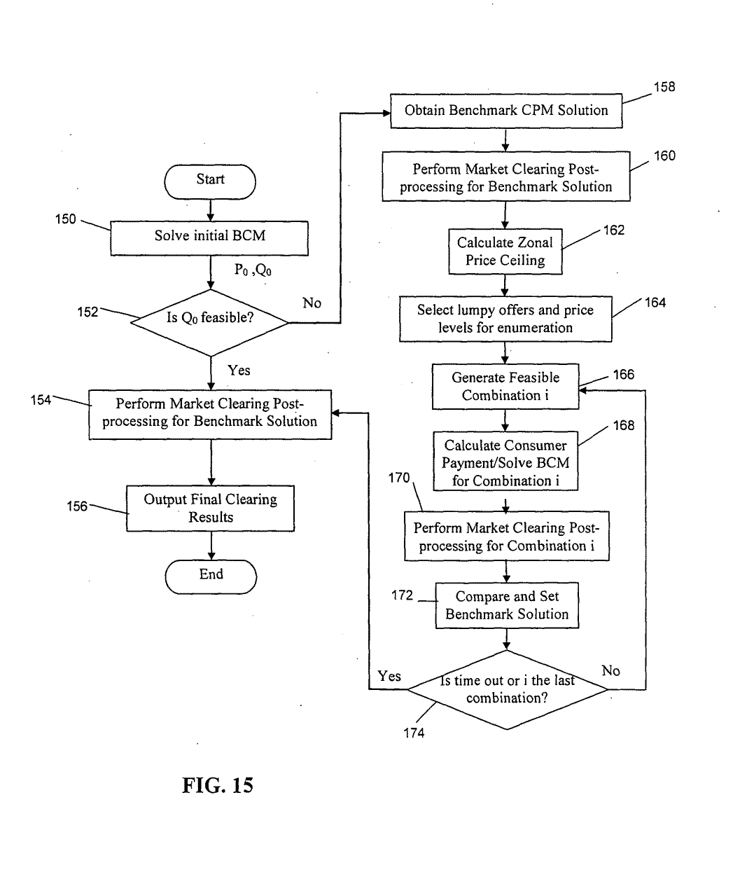

FIG. 15 shows the flowchart for one example embodiment of a method for clearing a forward capacity auction in accordance with the present invention. At step 150 an initial bid cost minimization problem is solved based on bids and offers received in the auction to provide a price-quantity set (Pₒ, Qₒ) that includes zonal price-quantity pairs for each zone that satisfy a market equilibrium condition. It can then be determined at step 152 if Q₀ is a feasible solution for a consumer payment minimization problem. If Q₀ is a feasible solution, then at step 154 market clearing post processing for the price-quantity set (Pₒ, Qₒ) may be performed and final clearing results for the auction can be output at step 156. For example, if all marginal blocks in Q₀ are rationable, it is indicative that the efficient resource allocation is achieved, and the auction clearing concludes.

If Q₀ is not a feasible solution, then a benchmark solution for a consumer payment minimization problem can be obtained at step 158, based on the bids and offers received in the auction. At least one zonal price ceiling may be calculated at step 162. A limited number of lumpy offers and price levels may be selected for enumeration at step 164. At least one feasible price/quantity combination may be generated at step 166 for the bids and offers which are based on the selected lumpy offers and price levels and are constrained by the at least one zonal price ceiling. A consumer payment for each of the generated price/quantity combinations may then be calculated at step 168. A smallest of the consumer payments may then be compared with a consumer payment calculated for the benchmark solution 172. If the smallest consumer payment is less than the consumer payment for the benchmark solution, then the benchmark solution may be set to correspond to the smallest consumer payment, and market clearing post processing may be performed for this reset benchmark solution (at step 154). Final clearing results for the auction may then be output at step 156.

Market clearing post processing for the benchmark solution may be performed at step 160.

In a further embodiment of the present invention, the method at step 168 may also comprise solving a further bid cost minimization problem for each of the generated price/quantity combinations to obtain corresponding solutions to the consumer payment minimization problem. Market clearing post processing for each of the corresponding solutions for the generated price/quantity combinations may be performed at step 170 to provide corresponding market clearing solutions. Each of the consumer payments may be based on the market clearing solution for the corresponding price/quantity combination.

When solving the initial bid cost minimization problem (step 150), all offer curves may be considered rationable. In addition, any interdependency of supply blocks are not considered, and economic minimum and minimum rationing limit constraints of capacity resources are not considered.

A supply curve for each bid may be obtained for use in solving the bid cost minimization problem. The obtaining of the supply curve may comprise applying a quantity rule to each supply block of the bid. The quantity rule may comprise a price cap for each block of a bid. A single-price bid that is subject to the quantity rule may be transformed into a linear price curve. The linear price curve may comprise a straight line which commences at a beginning of the block at a low price limit specified by the quantity rule and terminates at an end of the block at a high price limit specified by the quantity rule.

A demand curve for each demand bid may also be obtained for use in solving the bid cost minimization problem. The obtaining of the demand curve may comprise applying a quantity rule to each demand block of the bid. The quantity rule may comprise a price cap for each block of a bid. A single-price bid that is subject to the quantity rule may be transformed into a linear priced rational demand curve. The linear priced rational demand curve may comprise a straight line which commences at a beginning of the block at a high price limit specified by the quantity rule and terminates at an end of the block at a low price limit specified by the quantity rule.

Q₀ may comprise a feasible solution to the consumer minimization problem if all marginal blocks in Q₀ are rational.

In one embodiment of the present invention, the obtaining of the benchmark solution (step 150) for the consumer payment minimization problem based on the bids and offers received in the auction may comprise, for any lumpy supply offers that are partially cleared in the initial bid cost minimization problem, setting the cleared quantity to a size of the block for supply and to zero for demand. Then, the consumer payment minimization problem (step 158) may be solved as a second bid cost minimization problem to obtain the benchmark solution.

The calculating of the at least one zonal price ceiling at step 162 may comprise deriving a price ceiling for each import-constrained zone and a Rest-of-Pool (ROP) zone from P₀ and the benchmark solution. The price ceiling may be used in selecting the limited number of lumpy offers and price levels.

In a further example embodiment, for each import-constrained zone, if a local sourcing requirement constraint is binding, a zonal capacity clearing price for the corresponding import-constrained zone will be higher than a zonal capacity clearing price for the ROP and the price ceiling for the corresponding import-constrained zone will be a highest price that can be achieved based on the benchmark solution by minimizing the consumer payment for the zone and all its attached external interfaces that have the same market clearing price as the price of the import-constrained zone from the initial bid cost minimization solution. If the local sourcing requirements constraint is not binding, the price ceiling for the corresponding import-constrained zone is equal to the zonal capacity clearing price ceiling for the ROP.

The price ceiling for the ROP may be a highest price that can be achieved based on the benchmark solution by minimizing the consumer payment of all zones that have the same market clearing price as an ROP price from the initial bid cost minimization solution.

The at least one zonal price ceiling may further comprise a zonal price ceiling for an export-constrained zone. The price ceiling for the export-constrained zone may be the same as the price ceiling for the ROP.

Market clearing post processing (step 170) may comprise calculating market clearing prices based on the quantity Q₀ or the quantity obtained from each of the price/quantity combinations. In one example embodiment, the market clearing prices for each zone must be greater than or equal to a highest bid or offer price of all cleared bids or offers in the auction and. the market clearing prices must satisfy price separation conditions among capacity zones and external interfaces.

The market clearing post processing (step 170) may further comprise clearing of supply and demand side bids restricted by a quantity rule. The clearing of the bids may comprise separately determining a capacity clearing Q for each bid using the price P. The clearing of the supply side bids restricted by the quantity rule may comprise rejecting a bid that has a bid price less than a market clearing price such that capacity corresponding to the bid remains in the market and accepting a bid that has a bid price greater than or equal to the market clearing price such that capacity corresponding to the bid exits the market. Each of the bids restricted by the quantity rule may be considered lumpy such that they are either accepted or rejected in their entirety. The clearing of the demand side bids restricted by the quantity rule may comprise rejecting a bid that has a bid price less than a market clearing price such that capacity corresponding to the bid is not purchased and accepting a bid that has a bid price greater than or equal to the market clearing price such that additional demand is required. Each of the bids restricted by the quantity rule is considered lumpy such that it is either accepted or rejected in its entirety.

The market clearing post processing (step 170) may further comprise pro-rating tied rationale bids and offers. In such an embodiment, a ratio of an awarded quantity to a size of the bid or offer is equal for all tied bids or offers in the same zone. Further, a total difference between the ratios of any two connected zones that have the same market clearing prices must be in a minimum level.

The selecting of the lumpy offers and price levels (164) may comprise ranking all lumpy offers within each zone by price and removing all lumpy offers having a price higher than a price set by the zonal price ceiling. A price level may be added between any two adjacent lumpy blocks with different offer prices along the ranking. The price level may be set to a higher price of the prices for the two adjacent lumpy blocks. The zonal ceiling price may be added to the ranking to form a price-block list. The generating of the at least one feasible price/quantity combination may comprise locating a plurality of supply blocks from the price-block list that have a highest offer price cleared in the initial bid cost minimization problem. A priority of the located blocks may be set to a high priority in order of price. The priority of each element in the price-block list may be assigned according to a rank difference between each block and the block with the highest priority, a highest assigned priority corresponding to a smallest difference. A priority level may then be set, starting from the highest priority. An element from the price-block list may then be selected according to its priority to form a price/quantity combination. The priority of the element selected may be greater than or equal to the set priority level.

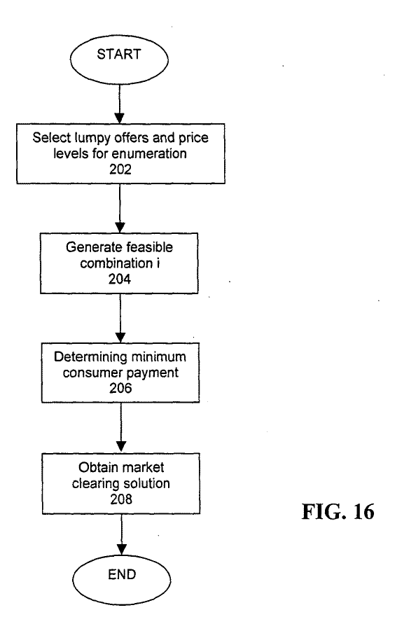

FIG. 16 shows a further embodiment of a method for clearing a forward capacity auction in accordance with the present invention. At step 202, a limited number of lumpy bids and offers received in the auction are selected. At step 204, a plurality of feasible price/quantity combinations may then be generated for the selected bids and offers. A minimum consumer payment may be determined from the plurality of feasible price/quantity combinations at step 206. A market clearing solution may be obtained based on the minimum consumer payment, at step 208.

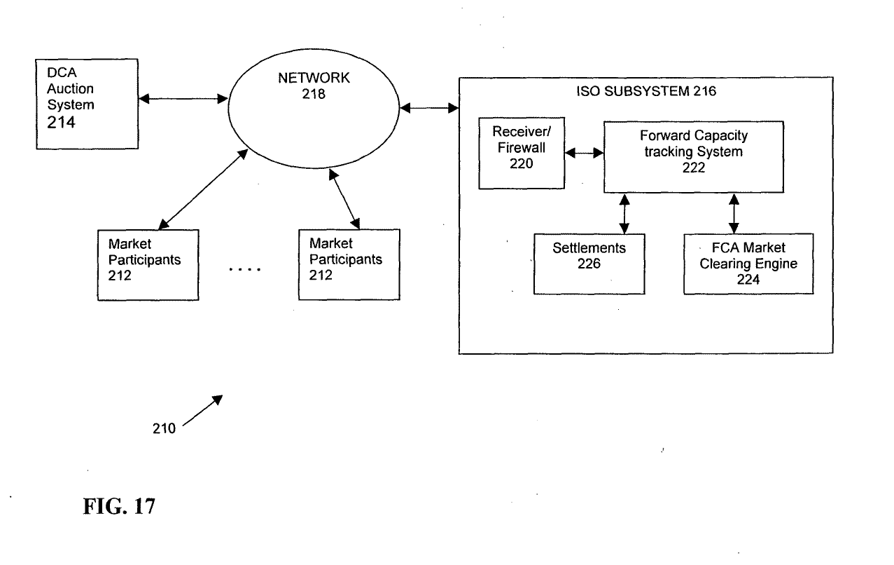

The present invention also includes apparatus and systems corresponding to the methods discussed above. FIG. 17 shows an example embodiment of a system 210 for clearing a forward capacity auction. Market participants 212 input bids and offers as discussed in detail above. A DCA auction system 214 conducts the forward capacity descending clock auction. An ISO subsystem 216 is also provided for clearing the results of the forward capacity auction. The DCA auction system 214 (which includes all apparatus and mechanisms for receiving bids and offers, conducting the auction, and outputting the results), the market participants 212, and the ISO subsystem 216 are connected via a suitable network 218.

The ISO system 216 includes means for selecting a limited number of lumpy bids and offers received in the auction (e.g., receiver/firewall 220 and forward capacity tracking system 222), and an FCA market clearing engine 224. The forward capacity tracking system 222 may track the DCA and receive the auction results. The ISO subsystem may also include a settlements module 226 for settling the auction based on the determined market clearing solution.

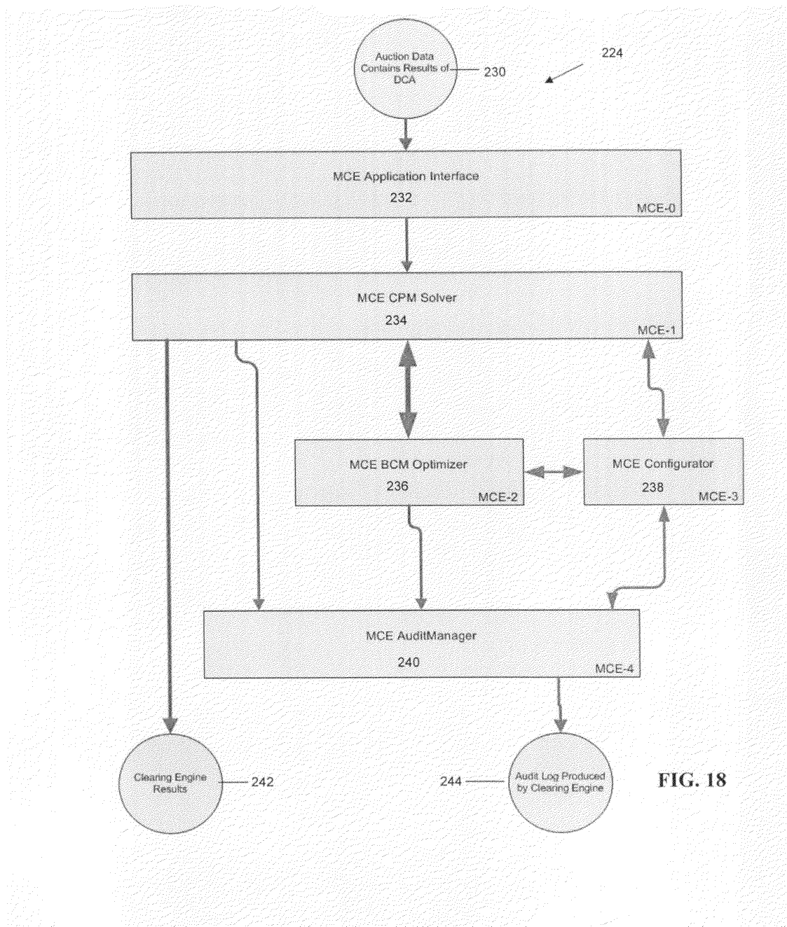

FIG. 18 shows an example embodiment of a market clearing engine 224 in accordance with the present invention. The market clearing engine 224 includes an MCE application interface 232 which receives auction data 230, an MCE CPM solver 234 which outputs clearing engine results 242, and interacting with a MCE BCM optimizer 236, an MCE configurator 238, and an MCE audit Manager 240, which outputs an audit log 244.

The auction data 230 includes all the input data from a database that includes the results from the descending clock auction.

The MCE application interface 232 enables an external program or human user to launch the market clearing engine 224. Run time parameters provide specific details needed for a successful execution of the MCE.

The MCE CPM solver 234 carries out the algorithm described above in connection with FIG. 15. The MCE CPM solver 234 includes, inter alia, means for generating a plurality of feasible price/quantity combinations for the selected bids and offers, and means for obtaining a feasible market clearing solution based on each price/quantity combination.

Further, the MCE CPM solver 234 software may also contain the application program functions needed to perform the following:
Instantiate the MCE's internal objects as needed;
Read and validate the MCE input data required by the clearing engine;
Transform the auction results input data into a form that is conducive to processing by the Bid Cost Minimization (BCM) optimizer 236 and Consumer Payment Minimization (CPM) Solver logic/heuristics;
Interface with the BCM optimizer 236 through an interface;
Implement the market rules, algorithms and heuristics germane to the CPM objective function;
Produce status reports for informational, success, warning, and error conditions, and record the information, in a defined format, in accordance with standard operating procedures;
Create and validate the market clearing engine output file containing the results obtained from execution; and
Implement runtime limit timeout logic.

The MCE BCM optimizer 236 solve initial BCM (step 150 of FIG. 15) and the BCM for combination i (Step 168 of FIG. 15). The BCM optimizer 236 provides the MCE CPM solver 234 with a Mixed Integer Programming (MIP), Quadratic and Linear Programming (LP) capability that efficiently identifies capacity offer bid blocks that optimally meet (based on lowest bid cost and known constraints) capacity requirements. A BCM approach is similar to finding the intersection of supply and demand curves to meet installed capacity requirement (ICR) or local sourcing requirements (LSRs). The BCM solves all the capacity zones simultaneously.

The BCM optimizer 236 may contain the application program functions needed to perform the following:
Populate the mathematical model required by CPLEX;
Invoke CPLEX Optimization engine to perform an FCM Optimization in accordance with the algorithms and processing logic defined in FIG. 15 (e.g. steps 150 and 168); and
Produce status reports for informational, success, warning, and error conditions, and record the information, in a defined format, in accordance with standard operating procedures.

The MCE configurator 238 is responsible for processing all auction parameter data contend in the MCE input data file. There are two categories of auction parameters:
Engine—Engine parameters define specific details pertaining to Market Clearing Engine execution; and
Market—Market parameters define specific details pertaining to one particular auction (e.g. ICR, CONE, etc.).
   The MCE configurator 238 is responsible for the processing and retrieval of both engine and market parameters. Other MCE components (e.g. CPM Solver 234 and BCM Optimizer 236) utilize the MCE Configurator's exposed methods to get and set these parameters during runtime.

The MCE Audit Manager 240 is a program module that records status messages within the file identified by a LogFile parameter within the MCE Application Interface 232.

The clearing engine results 242 output by the MCE CPM solver 234 is the final solution used for the FCA clearing.

The audit log 244 is produced by clearing engine and comprises a log file that records the information of the execution of the MCE.

Certain of aspects of the present invention are explained in more detail below, with reference to FIG. 15.

Solve Initial BCM (Step 150)

This procedure produces an unconstrained solution for the CPM problem when applied. The following assumptions may be made for solving the BCM.
All the offer curves are rationable, no lumpy blocks are modeled.
Interdependencies among supply blocks are withdrawn from the BCM.
No EcoMin and minimum rationing limit constraints are considered.

Under the above assumption, the initial BCM problem becomes a quadratic programming problem. After solving the initial BCM problem, the marginal price for each zone is derived from the shadow prices of binding constraints in the BCM problem. The price-quantity pair (Q^{o}, P^{o}) that satisfies the market equilibrium condition in a convex system is obtained.

Obtain Benchmark CPM Solution (Step 158)

This process generates a feasible CPM solution. After solving the initial BCM problem, the quantity Q₀ can be feasible for the CPM problem, except that some lumpy offers are partially cleared in the initial BCM. Those blocks must be marginal blocks. Note that there may be multiple partially-cleared lumpy blocks, since the BCM solves all the capacity zones simultaneously. If a lumpy block is partially cleared, set the cleared quantity to its block size for a supply block and zero for a demand block. Another BCM problem may be solved by fixing all partially cleared lumpy offers in the initial solution, and quantity Q₁ is obtained. Note that the sum of Q₁ is always greater than or equals the total amount of Qₒ. Therefore Q₁ is a feasible solution for the CPM problem. Q₁ is defined as the benchmark quantity.

Perform Market Clearing Post-Processing (Steps 154, 160, 170)

After obtaining the clearing quantities from BCM, the post-processing procedures for the following area will be performed:
1. Determine CCP
2. Clear de-list bids restricted by the quantity rule
3. Pro-rate tied rationable bids/offers
4. Calculate the total Consumer Payment

1. Determine CCP

Given the cleared Q, the pricing procedure can be performed to obtain the market clearing price CCP. The market price determination procedure is described in the section entitled “Capacity Market Clearing Price Determination” above.

The following conditions may be tested to determine the market clearing price.

1.a. For an import-constrained zone

∀z ∈ Zₗ, if for some

$$r ∈ {R}_{z} ⋃ ( {⋃}_{e {∈}_{{z}_{s}}} {R}_{e} )$$

for which p_{b}^{r} (q_{b}^{r})>EORP_{z}, and satisfies the following condition

$${EQ}_{z} + {EQ}_{z}^{RT} + {\sum }_{e ∈ {E}_{s}} [ {EQ}_{e} ] - {q}_{r}^{min} \geq L S {R}_{z}$$

$$then$$

$$C C {P}_{z} = C C {P}_{ROP}$$

Where
b ∈ Bᵣ is the last block cleared for resource r.

$${q}_{r}^{min} = \{ \begin{matrix}0 & if r is rationable \\ {q}_{b}^{r} & if r is lumpy and r ∈ {R}_{z}^{N} \\ min ( {q}_{b}^{r} , max ( 0 , E C L - {\sum }_{r ∈ {R}_{z}^{RT}}^{ } {q}^{r} + {q}_{b}^{r} ) ) & if r is lumpy and r ∈ {R}_{z}^{RT}\end{matrix}$$

1.b. For an export-constrained zone

∀z ∈ Z_{E}, if there are some

$$r ∈ {R}_{z} ⋃ ( {⋃}_{e {∈}_{{z}_{s}}} {R}_{e} )$$

such that

$${EQ}_{z} + {EQ}_{z}^{RT} + {\sum }_{e ∈ {E}_{s}} [ {EQ}_{e} ] + {uq}_{r}^{min} \leq M C {L}_{z}$$

$$then$$

$$C C {P}_{z} = C C {P}_{ROP}$$

Where uqᵣ^{min} is the minimum quantity that can be cleared. It can be defined in the following

a) If the resource is a non-RTEG resource and located in zone z (r ∈ R_{z}^{N}), then

$${uq}_{r}^{min} = \{ \begin{matrix}{\overline{q}}_{b}^{r} & if {p}_{b}^{r} ( {\overline{q}}_{b}^{r} ) \leq C C {P}_{rop} and lumpy \\ 0 & if {p}_{b}^{r} ( 0 ) \leq C C {P}_{rop} and rationable \\ ∞ & otherwise\end{matrix}$$

Where b is the first block that is not cleared on the supply curve.

b) If the resource is a RTEG resource (r ∈ R_{z}^{RT}), then

$${uq}_{r}^{min} = \{ \begin{matrix}min ( {\overline{q}}_{b}^{r} , E C {L}_{z} - {\sum }_{r ∈ {R}_{z}^{RT}}^{ } {q}^{r} ) & \begin{matrix}if E C {L}_{z} > {\sum }_{r ∈ {R}_{z}^{RT}}^{ } {q}^{r} , and \\ {p}_{b}^{r} ( {\overline{q}}_{b}^{r} ) \leq C C {P}_{rop} and lumpy\end{matrix} \\ 0 & \begin{matrix}if E C {L}_{z} > {\sum }_{r ∈ {R}_{z}^{RT}}^{ } {q}^{r} , and \\ {p}_{b}^{r} ( 0 ) \leq C C {P}_{rop} and rationable\end{matrix} \\ ∞ & otherwise\end{matrix}$$

c) If the resource is located in external zone of the zone z (r ∈ R_{E}_{_{z}}), then

$${uq}_{r}^{min} = \{ \begin{matrix}0 & \begin{matrix}if E C {L}_{z} > {\sum }_{r ∈ {R}_{z}^{RT}}^{ } {q}^{r} , and \\ {p}_{b}^{r} ( {\overline{q}}_{b}^{r} ) \leq C C {P}_{rop} and rationable\end{matrix} \\ ∞ & otherwise\end{matrix}$$

2. Clear De-List Bids Restricted by the Quantity Rule

A BCM solution (P, Q) is derived from the equivalent supply/demand curves of resources. If an existing resource submits a de-list bid that is restricted by the quantity rule, its equivalent offer curve will be different from its actual offer curve. And therefore, the quantity cleared using the equivalent offer curve (Q) can be different from its settlement obligation. So, a separate procedure is performed to determine the capacity clearing for those de-list bids restricted by the quantity rule using the clearing price P. The clearing rules are described in the section entitled “Market Clearing Rules and Conditions” above. Ultimately, the settlement quantity Q^{S} is determined.

3. Pro-Rate Tied Rationable Bids/Offers

When two or more rationable bids/offers with the same bid/offer price are to be cleared partially in the auction, their clearing will be proportional to their bid block size. This procedure is applied only to rationable bids/offers without the consideration of EcoMin. The tie-breaking prorating procedure includes application to inter-zonal tie-breaking and intra-zone tie-breaking. The tie-breaking can be solved by an LP problem, and the procedure is described below.
Identify all the potential tie-breaking sets (PTBS). Every PTBS is comprised of zones and interfaces with same capacity clearing price that are connected to each other. A PTBS can contain multiple or single zone(s)/interface(s). As a result, the set of PTBS is obtained:

ψ={ψᵢ, i=1, N}, where N is the total number of PTBS. Each ψᵢ includes a set of branches Bᵢ, which indicates the connectivity among internal and external zones. For example, assuming CT, BSTN, ROP, and ME zones are in a PTBS, there will be three branches, CT to ROP, BSTN to ROP, and ROP to ME.
Identify the corresponding “tie-breaking” price Pᵢ for each PTBS ψᵢ. The “tie-breaking” price pᵢ is the highest price of any rationable block that is partially or completely cleared for all zones/interfaces included in the current ψᵢ [Note; the block is considered cleared if it has obligation quantity >0].
Create a supper block SB_{z} for each zone z based on price Pᵢ. The super-block contains all rationable blocks with price equal to the tie-breaking price Pᵢ. To be considered as a part of the super-block, a block has to be the last cleared block of the curve or not cleared at all but the preceding lumpy block must be cleared or the first block of the supply curve (and the EcoMin is 0). The size of the super-block SB_{z} is the sum of the offered capacity of each tied block.
Calculate the initial cleared quantity SB_{z}^{o} for each zone which is the sum of all cleared capacity from tied blocks that form the super-block before breaking the tied solution.
Calculate the LSR for tied blocks for an import-constrained zone LSR_{z}^{t}, which equals the maximum of zero and the difference between LSR and the total cleared capacity from the non-tied blocks that are utilized to satisfy the LSR.
Calculate the maximum import limit of an external interface for the tied blocks I_{e,t}^{max}, which equals the maximum of zero and the difference between the import limit and total cleared capacity from the non-tied blocks in the external zone.
Calculate the MCL of an export-constrained zone for tied blocks MCL_{z}^{t}, which equals the maximum of zero and the difference between the MCL and total cleared capacity from non-tied blocks that are restricted by the MCL.
Solve an LP problem to determine the inter-zonal prorating ratio. The LP problem is described below:

$$min {\sum }_{i = 1}^{M} {\sum }_{br ∈ {B}_{z}} ( {ts}_{br}^{f} + {ts}_{br}^{t} )$$

$$ST . \\ {\sum }_{z ∈ {ψ}_{i}} ( {ρ}_{z} \cdot {SB}_{z} ) = {\sum }_{z ∈ {ψ}_{i}} ( {SB}_{z}^{o} ) for any i = 1 … N$$

$${ρ}_{{br}_{f}} + {ts}_{br}^{f} = {ρ}_{{br}_{i}} + {ts}_{br}^{t}$$

for any br ∈ Bᵢ and i=1 . . . N

$${ρ}_{z} \cdot {SB}_{z} + {\sum }_{e ∈ {E}_{s} }^{ } [ {ρ}_{e} \cdot {SB}_{e} ] \geq L S {R}_{z}^{t}$$

for an import-constrained zone z.

$${ρ}_{z} \cdot {SB}_{z} + {\sum }_{e ∈ {E}_{s}}^{ } [ {ρ}_{e} \cdot {SB}_{e} ] \leq M C {L}_{z}^{t}$$

for any export-constrained zone z,

ρₑ·SBₑ≦Iₑ^{t,max} for any external zone e ∈ E

ts_{br}^{f}, ts_{br}^{t}, ρ≧0

where

ts_{br}^{f} and ts_{br}^{t} are the tie-breaking slacks for two connected zones in a PTBS,

ρ_{z} is the tie-breaking ratio for an internal zone z or external zone e,

br is the index of the branches, representing the connectivity among internal and external zones

br_{f} and brₜ are the from and to zones of a branch.
Calculate the cleared quantity for each tied supply block by multiplying the block size by the zonal tie-breaking ratio obtained from the LP solution.

4. Calculate Total Consumer Payment

The total consumer payment is calculated using Q^{S} and P, assuming each capacity obligation will be paid its zonal capacity clearing price.

Calculate Zonal Price Ceiling (Step 162)

To manage the likelihood of price escalation in an import-constrained zone, a price ceiling for each import-constrained zone and ROP is derived from (P₀, Q₁). This price ceiling is used to limit the number of combinations in searching for the minimum consumer payment solution without driving up price in the import-constrained zone.

1. For each import-constrained zone,

a. If the LSR constraint is binding, its zonal capacity clearing price will be higher than that of the ROP. The price ceiling for the zone will be

$${\overline{CCP}}_{z} = \frac{\{ {\sum }_{r ∈ {R}_{s}}^{ } ( {α}_{r} \cdot {q}^{r} ) + {\sum }_{r ∈ {E}_{s}}^{ } [ ( 1 - {δ}_{e} ) \cdot {\sum }_{r ∈ {R}_{s}}^{ } ( {α}_{r} \cdot {q}^{r} ) ] \} \cdot {CCP}_{z}}{{LSR}_{z} - {\sum }_{e ∈ {E}_{s}}^{ } [ {δ}_{e} \cdot {I}_{e}^{max} ]} .$$

Where δₑ is a binary variable that indicates whether the maximum import limit is binding in the initial BCM solution.

b. If LSR constraint is not binding, its price ceiling will be the same as that of ROP, which is calculated in the next step.

2. For ROP, the price ceiling is calculated as

$${\overline{CCP}}_{ROP} = \frac{\{ \begin{matrix}{\sum }_{z = s} [ {\sum }_{r ∈ {R}_{z}} ( {α}_{r} \cdot {q}^{r} ) ] + \\ {\sum }_{z ∈ {Z}_{i} ⋃ {Z}_{z}} [ ( 1 - {δ}_{z} ) \cdot ( \begin{matrix}{\sum }_{r ∈ {R}_{z}} ( {α}_{r} \cdot {q}^{r} ) + \\ {\sum }_{e ∈ {E}_{s}} ( ( 1 - {δ}_{e} ) \cdot {\sum }_{r ∈ {R}_{s}} ( {α}_{r} \cdot {q}^{r} ) )\end{matrix} ) ]\end{matrix} \} \cdot C C {P}_{ROP}}{\begin{matrix}I C R - {\sum }_{z ∈ {Z}_{I}} [ {δ}_{z} \cdot L S {R}_{z} + {\sum }_{e ∈ {E}_{z}} ( ( 1 - {δ}_{z} ) \cdot {δ}_{e} \cdot {I}_{e}^{max} ) ] - \\ {\sum }_{z ∈ {Z}_{s}} [ {δ}_{z} M C {L}_{z} + {\sum }_{e ∈ {E}_{s}} ( ( 1 - {δ}_{z} ) \cdot {δ}_{e} \cdot {I}_{e}^{max} ) ]\end{matrix}} .$$

Where δ_{z} is a binary variable that indicates whether the LSR or MCL constraint is binding in the initial BCM solution.

If the price ceiling for the ROP is higher than the price ceiling for any of the import-constrained zones, it will be set to the lowest value of all import-constrained zones.

3. The price ceiling for an export-constrained zone will be the same as that of ROP.

Select Lumpy Offers and Price Levels for Enumeration (Step 164)

The following procedure may be adopted for internal capacity zones to select lumpy offers and price levels for enumeration.
Rank all lumpy offer blocks within the zone from low to high price.
Remove all lumpy offers with price higher than the zonal ceiling price C̅C̅P̅_{z}.
Add a price level between any two adjacent lumpy blocks with different offer prices along the rank. The price level is set to the higher price of the two lumpy blocks.
Add the ceiling price to the rank, and form a price-block list.

Generate Feasible Combination (Step 166)

The following steps are used to generate a feasible combination of price-levels.
Find the supply blocks with the highest offer price cleared in the initial BCM solution in the list, and set the priority of such block to the highest.
Assign the priority for each element in the price-block list according to the rank difference between the element and the one with the highest priority. The smaller the difference is, the higher the priority of the element is.
Set a priority level (starting from the highest level of priority), and select one element from the zonal list according to its priority to form a combination. The element that is considered in the generation of a combination should always have a priority level that is higher than or equal to the selected priority level.

Solve BCM for a Combination (Step 168)

Given a combination of price-block levels, the BCM may be solved with MIP technique with the following additional constraints. For each selected combination, if the element for the zone is a supply block, this lumpy supply block will be fixed at its block size. The demand bid in the zone with price that is lower than the price of the element will be set zero. If the element is a price level, no demand bid will be restricted by such price. For each combination, all supply offers in the zone with prices that are higher than the price of the selected element will be set to zero.

Compare and Set the Benchmark Solution (Step 172)

For a feasible combination, determine the zonal CCP and calculate the total consumer payment after solving BCM. The comparison may be done in the following way:
If the consumer payment is less than that of the benchmark solution, set the benchmark solution to this current combination.
If the consumer payment is equal to that of the benchmark solution, the tie-breaking situation exists.
If the total capacity cleared for the combination is higher than that of the benchmark, set the benchmark solution to this combination.
If the total capacity cleared for the combination is equal to that of the benchmark, compare the total as-bid cost adjusted by the market share information for the lumpy offers. Set the benchmark solution to the outcome with the lower as-bid cost.
If the total as-bid cost is the same as the benchmark solution, a tied solution exists. Each tied block is marked in the benchmark solution.

Bid-Based Cost Minimization

The conventional approach of selecting the winning bids is based on minimazing as-bid cost from all capacity bids/offers. Each de-list bid in BCM is aggregated into an equivalent supply curve with multiple blocks. In general, the problem can be described as

Minimize Total Bid Cost

Subject to:
Supply Meets Demand (ICR and LSR)
External Interface Limits and MCL
Supply Clearing Dependency
Block and Resource Level Constraints

This problem solves only for the cleared quantity. The market clearing price has to be derived ex post. The objective function is quadratic due to the quantity rule. The BCM problem is non-convex due to the lumpy nature of the supply/demand bids. In short, the BCM is a quadratic mixed integer programming problem, which can be solved using a commercial solver.

In the following, the BCM problem and pricing procedures are described in detail.

Objectives

The objective is to minimize the total as-bid cost integrated along the supply/demand curve and the penalties that are used to implement the market clearing rules. That is to

Min TBC+TPC.

TBC is the total amount that the equivalent suppliers are willing to provide in the auction or total bid cost, and

$$T B C = {\sum }_{r ∈ R} {\sum }_{b ∈ {B}_{r}} ( {α}_{r} \cdot {\int }_{0}^{{q}_{b}^{r}} {p}_{b}^{r} ( x ) \cdot d x ) \qquad ( 1 )$$

The total penalty term includes items that are used to implement the market rules for feasibility, and tie-breaking based on market-share.

TPC=TPC_{f}+TPCₒ+TPC_{tb}. (2)

TPC_{f} is the cost item used to handle CPM infeasibility. A slack penalty is assigned to each import-constrained zone and the ROP zone. This is used to implement the pricing when there is not enough supply. The total penalty term is

$$T P {C}_{f} = {\sum }_{z ∈ {Z}_{i}} ( {pc}_{f}^{z} \cdot {s}_{z} ) + {pc}_{f}^{s} \cdot {s}_{s} . \qquad ( 3 )$$

TPCₒ is the cost item used to handle CPM optimality. Currently only the price-setting penalty is considered for the export-constrained zones and external zones. This penalty is to give preference in the market clearing to resources in the export-constrained zones and external zones, such that those resources have the potential to set the clearing prices of the zones at lower values.

$${TPC}_{o} = {pc}_{ps} \cdot [ {\sum }_{z ∈ {Z}_{z}}^{ } {\sum }_{r ∈ {R}_{s}} ( {q}^{r} ) + {\sum }_{e ∈ E}^{ } ( {\sum }_{r ∈ {R}_{s}}^{ } ( {q}^{r} ) ) ] . \qquad ( 4 )$$

TPC_{tb} is the total penalty cost for tie-breaking based on the market share information. The penalty is applied only to lumpy offers. No market share adjustment for demand bids is adopted.

$${TPC}_{tb} = {pc}_{tb} \cdot [ {\sum }_{z ∈ Z}^{ } {\sum }_{r ∈ {R}_{s}} ( {q}^{r} \cdot {MS}_{r} ) ] . \qquad ( 5 )$$

Constraints

(2.1) ICR requirement for the pool

The total effective capacity supply cleared in the auction must be higher than or equal to the ICR.

$${\sum }_{z ∈ Z}^{ } [ {EQ}_{z} + {EQ}_{z}^{RT} + {s}_{z} ] + {\sum }_{e ∈ E}^{ } [ {EQ}_{e} ] + {s}_{s} \geq ICR . \qquad ( 6 )$$

(2.2) LSR constraint for the import-constrained zone

The effective capacity supply cleared in an import-constrained capacity zone and the external capacity zones/interfaces connected to it must satisfy its minimum local sourcing requirement.

$${EQ}_{z} + {EQ}_{z}^{RT} + {\sum }_{e ∈ {E}_{z}}^{ } [ {EQ}_{e} ] + {s}_{z} \geq {LSR}_{z} for any z ∈ {Z}_{I} . \qquad ( 7 )$$

(2.3) MCL constraint for the export-constrained zone

The effective capacity supply cleared in an export-constrained capacity zone and the external capacity zones/interfaces connected to it must satisfy its maximum capacity limit.

$${EQ}_{z} + {EQ}_{z}^{RT} + {\sum }_{e ∈ {E}_{z}}^{ } [ {EQ}_{e} ] \leq {MCL}_{z} for any z ∈ {Z}_{E} , \qquad ( 8 )$$

(2.4) External Interface Limits

The effective capacity supply cleared at an external zone/interface cannot exceed the import limit.

EQₑ≦Iₑ^{max} for any e ∈ E . (9)

(2.5) Limitation on Effective Supply

The effective capacity supply cleared at an internal zone z from non-RTEG resources cannot exceed the total capacity cleared from non-RTEG resources in the zone.

$${EQ}_{z} \leq {\sum }_{r ∈ {R}_{z}^{N}}^{ } ( {α}_{r} \cdot {q}^{r} ) for any z ∈ Z . \qquad ( 10 )$$

The effective capacity supply cleared at an internal zone z from RTEG resources cannot exceed the total capacity cleared from RTEG resources in the zone.

$${EQ}_{z}^{RT} \leq {\sum }_{r ∈ {R}_{z}^{RT}}^{ } ( {α}_{r} \cdot {q}^{r} ) for any z ∈ Z . \qquad ( 11 )$$

The effective capacity supply cleared at an internal zone z from RTEG resources cannot exceed the zonal RTEG capacity limit.

EQ_{z}^{RT}≦ECL_{z} for any z ∈ Z. (12)

The effective capacity supply cleared at an external zone e cannot exceed the total capacity cleared in the zone.

$${EQ}_{e} \leq {\sum }_{r ∈ {R}_{e}}^{ } ( {α}_{r} \cdot {q}^{r} ) for any e ∈ E . \qquad ( 13 )$$

(2.6) End-of-round Conditions

The cleared quantity for a resource must be no less than the quantity cleared at the end-of-round price of the last round in the DCA.

αᵣ·q^{r}≧αᵣ·qₒ^{r} for any r ∈ R. (14)

(2.7) Resource Level Constraints

The total cleared quantity for a resource must be equal to the sum of the quantity cleared for each supply block.

$${q}^{r} = {\sum }_{b ∈ {B}_{r}}^{ } {q}_{b}^{r} for any r ∈ R . \qquad ( 15 )$$

Each supply block quantity cleared must be within the bounds.

q^{r}≧0 for any r ∈ R. (16)

q_{b}^{r}≦ q̅_{b}^{r} for any r ∈ R. (17)

(2.8) Block Level Quantity Constraints

Certain constraints must be applied to the cleared quantity of a lumpy single-price block. For any r ∈ R_{z} and b ∈ Bᵣ^{LS},

q_{b}^{r}= q̅_{b}^{r}·u_{b}^{r} (18)

Note that this constraint does not apply when no lumpy offer is present in the BCM problem.

(2.9) Block Dependency Constraints

When all supply blocks of a resource are economic, enforcing the equilibrium constraint on the individual block level will not create problems in the market clearing. However, lumpiness and rationing rules do introduce problems in determining the clearing quantity. In some scenarios, a block's clearing status depends on the clearing status of other blocks.

Currently block dependency is only modeled for any two blocks on the same offer curve as the following: If block b cannot be cleared with any amount unless the block b′ is cleared at its maximum, we have,

$$\frac{{q}_{{b}^{*}}^{r}}{{\overline{q}}_{{b}^{*}}^{r}} \geq \frac{{q}_{b}^{r}}{{\overline{q}}_{b}^{r}} . \qquad ( 19 )$$

Control Variables

The control variables in this optimization problem are clearing quantities (q_{b}^{r} and q^{r}), and intermediate variables (u_{b}^{r}, sₛ, s_{z}, EQ_{z}, EQ_{z}^{RT} and EQₑ).

Solution Technique

Mixed integer quadratic constrained programming is used to solve the BCM problem.

Pricing Procedure

When lumpiness is present in the BCM problem, no good definition of market clearing price exists that satisfies the market equilibrium conditions. The concept of marginal pricing is not applicable under such a scenario. Capacity clearing price will be determined based on the pricing rules described in the section entitled “Capacity Market Clearing Price Determination” above.

Consumer Payment Calculation

After determining the market clearing price of each zone, we must calculate the quantity to be settled in the FCA. The cleared quantity in the BCM solution is the equivalent supply, which includes the deferred purchase that results from application of the quantity rule. The overall procedure of consumer payment calculation is described as follows.
Calculate the supply from each de-list bid that is restricted by the quantity rule.

Assume the offer price is constant (that is p_{b}^{r}(q_{b}^{r})=c_{b}^{r}), we have the following conditions for any r ∈ R_{z} and b ∈ Bᵣ^{QRD}:

For a supply-side resource, we have

$${q}_{b}^{r} = \{ \begin{matrix}{\overline{q}}_{b}^{r} & if {CCP}_{z} \geq {c}_{b}^{r} \\ 0 & if {CCP}_{z} < {c}_{b}^{r}\end{matrix} , \qquad ( 20 )$$

For a demand-side resource, we have

$${q}_{b}^{r} = \{ \begin{matrix}0 & if {CCP}_{z} \geq {c}_{b}^{r} \\ {\overline{q}}_{b}^{r} & if {CCP}_{z} < {c}_{b}^{r}\end{matrix} , \qquad ( 21 )$$

Determine the total amount to be settled in the FCA.

The total cleared settlement quantity must be equal to the sum of the quantity cleared for each equivalent supply block that is not restricted by the quantity rule and the quantity cleared for de-list bids that are capped by the quantity rule.

$${sq}^{r} = {q}^{r} - {\sum }_{b ∈ {B}_{r}^{QRZ}}^{ } {q}_{b}^{r} + {\sum }_{b ∈ {B}_{r}^{QRD}}^{ } {q}_{b}^{r} for any r ∈ R . \qquad ( 22 )$$

Calculate the generator payments using the settlement quantities and the market clearing prices. The total consumer payment can be calculated using the following equation:

$$Payment = {\sum }_{z ∈ Z}^{ } [ {CCP}_{z} \cdot ( {\sum }_{r ∈ {R}_{z}^{N}}^{ } ( {α}_{r} \cdot {sq}^{r} ) + dr \cdot {\sum }_{r ∈ {R}_{z}^{RT}}^{ } ( {α}_{r} \cdot {sq}^{r} ) ) ] + {\sum }_{e ∈ E}^{ } [ {CCP}_{e} \cdot {\sum }_{r ∈ {R}_{z}}^{ } ( {α}_{r} \cdot {sq}^{r} ) ] \qquad ( 23 )$$

Where dr is the discount rate for the RTEG resource, and

$$dr = min ( 1 , \frac{ECL}{{\sum }_{z ∈ Z}^{ } {\sum }_{r ∈ {R}_{z}^{RT}}^{ } ( {α}_{r} \cdot {sq}^{r} )} )$$

Note that this section is not intended to be used to perform any detailed settlement calculation. It is only used to facilitate the auctioneer in clearing the market.

Back-Up BCM

In an alternate example embodiment, a back-up BCM may be used which seeks to solve multiple capacity zones simultaneously using a MIP solver. The solution produced by this back-up BCM can be used to replace the initial solution of the heuristic CPM, since it is a feasible solution for the CPM problem. This approach will be used only if the solution produces the lowest cost.

Different from the heuristic CPM, the back-up BCM adopts the following procedure:
Perform the same sequence as the heuristic BCM, and obtain a benchmark solution.
Solve the BCM respecting the lumpiness of all bids/offers. Calculate the consumer payment.
Compare the consumer payment with the benchmark solution, and report the outcome with the lower consumer payment.

The idea of a back-up BCM is an attempt to avoid the time-consuming enumeration process.

It should now be appreciated that the present invention provides advantageous methods, apparatus, and systems for clearing a forward capacity auction.

Although the invention has been described in connection with various illustrated embodiments, numerous modifications and adaptations may be made thereto without departing from the spirit and scope of the invention as set forth in the claims.

What is claimed is:

1. A method for clearing a forward capacity auction, comprising:
solving an initial bid cost minimization problem based on bids and offers received in the auction to provide a price-quantity set (Pₒ, Qₒ) that includes zonal price-quantity pairs for each zone that satisfy a market equilibrium condition;
determining if Q₀ is a feasible solution for a consumer payment minimization problem;
if Q₀ is a feasible solution, then:
performing market clearing post processing for the price-quantity set (Pₒ, Qₒ);
and
outputting final clearing results for the auction;
if Q₀ is not a feasible solution, then:
obtaining an benchmark solution for a consumer payment minimization problem based on the bids and offers received in the auction;
calculating at least one zonal price ceiling;
selecting a limited number of lumpy offers and price levels for enumeration;
generating at least one feasible price/quantity combination for the bids and offers which are based on the selected lumpy offers and price levels and are constrained by the at least one zonal price ceiling;
calculating a consumer payment for each of the generated price/quantity combinations;
comparing a smallest of the consumer payments with a consumer payment calculated for the initial benchmark solution;
if the smallest consumer payment is less than the consumer payment for the initial benchmark solution, then:
resetting the benchmark solution to correspond to the smallest consumer payment;
performing market clearing post processing for the reset benchmark solution;
and
outputting final clearing results for the auction.

2. A method in accordance with claim 1, further comprising:
performing market clearing post processing for the benchmark solution.

3. A method in accordance with claim 1, further comprising:
solving a further bid cost minimization problem for each of the generated price/quantity combinations to obtain corresponding solutions to the consumer payment minimization problem;
performing market clearing post processing for each of the corresponding solutions for the generated price/quantity combinations to provide corresponding market clearing solutions;
wherein each of the consumer payments is based on the market clearing solution for the corresponding price/quantity combination.

4. A method in accordance with claim 1, wherein for the solving of the initial bid cost minimization problem:
all offer curves are deemed to be rationable;
interdependency of supply blocks are not considered; and
economic minimum and minimum rationing limit constraints of capacity resources are not considered.

5. A method in accordance with claim 1, further comprising:
obtaining a supply curve for each bid for use in solving the bid cost minimization problem.

6. A method in accordance with claim 5, said obtaining of the supply curve comprises:
applying a quantity rule to each supply block of the bid.

7. A method in accordance with claim 6, wherein said quantity rule comprises a price cap for each block of a bid.

8. A method in accordance with claim 6, wherein a single-price bid that is subject to the quantity rule will be transformed into a linear price curve.

9. A method in accordance with claim 8, wherein the linear price curve comprises a straight line which commences at a beginning of the block at a low price limit specified by the quantity rule and terminates at an end of the block at a high price limit specified by the quantity rule.

10. A method in accordance with claim 1, further comprising:
obtaining a demand curve for each demand bid for use in solving the bid cost minimization problem.

11. A method in accordance with claim 10, said obtaining of the demand curve comprises:
applying a quantity rule to each demand block of the bid.

12. A method in accordance with claim 11, wherein said quantity rule comprises a price cap for each block of a bid.

13. A method in accordance with claim 11, wherein a single-price bid that is subject to the quantity rule will be transformed into a linear priced rational demand curve.

14. A method in accordance with claim 13, wherein the linear priced rational demand curve comprises a straight line which commences at a beginning of the block at a high price limit specified by the quantity rule and terminates at an end of the block at a low price limit specified by the quantity rule.

15. A method in accordance with claim 1, wherein Q₀ comprises a feasible solution to the consumer minimization problem if all marginal blocks in Q₀ are rational.

16. A method in accordance with claim 1, wherein said obtaining of the benchmark solution for the consumer payment minimization problem based on the bids and offers received in the auction comprises:
for any lumpy supply offers that are partially cleared in the initial bid cost minimization problem, setting the cleared quantity to a size of the block for supply and to zero for demand; and
solving the consumer payment minimization problem as a second bid cost minimization problem to obtain the benchmark solution.

17. A method in accordance with claim 1, wherein said calculating of the at least one zonal price ceiling comprises:
deriving a price ceiling for each import-constrained zone and a Rest-of-Pool (ROP) zone from P₀ and the benchmark solution;
wherein the price ceiling is used in selecting the limited number of lumpy offers and price levels.

18. A method in accordance with claim 17, wherein for each import-constrained zone:
if a local sourcing requirement constraint is binding, a zonal capacity clearing price for the corresponding import-constrained zone will be higher than a zonal capacity clearing price for the ROP and the price ceiling for the corresponding import-constrained zone will be a highest price that can be achieved based on the benchmark solution by minimizing the consumer payment for the zone and all its attached external interfaces that have the same market clearing price as the price of the import-constrained zone from the initial bid cost minimization solution;
if the local sourcing requirements constraint is not binding, the price ceiling for the corresponding import-constrained zone is equal to the zonal capacity clearing price ceiling for the ROP.

19. A method in accordance with claim 17, wherein the price ceiling for the ROP is a highest price that can be achieved based on the benchmark solution by minimizing the consumer payment of all zones that have the same market clearing price as an ROP price from the initial bid cost minimization solution.

20. A method in accordance with claim 17, wherein the at least one zonal price ceiling further comprises a zonal price ceiling for an export-constrained zone.

21. A method in accordance with claim 20, wherein the price ceiling for the export-constrained zone is the same as the price ceiling for the ROP.

22. A method in accordance with claim 1, wherein market clearing post processing comprises:
calculating market clearing prices based on the quantity Q₀ or the quantity from each of the price/quantity combinations;
wherein:
the market clearing prices for each zone must be greater than or equal to a highest bid or offer price of all cleared bids or offers in the auction; and.
the market clearing prices must satisfy price separation conditions among capacity zones and external interfaces.

23. A method in accordance with claim 22, wherein the market clearing post processing further comprises:
clearing of supply and demand side bids restricted by a quantity rule.

24. A method in accordance with claim 23, wherein said clearing of said bids comprises:
separately determining a capacity clearing Q for each bid using the price P.

25. A method in accordance with claim 23, wherein said clearing of said supply side bids restricted by the quantity rule comprises:
rejecting a bid that has a bid price less than a market clearing price such that capacity corresponding to the bid remains in the market;
accepting a bid that has a bid price greater than or equal to the market clearing price such that capacity corresponding to the bid exits the market; and
wherein each of said bids restricted by the quantity rule are considered lumpy such that they are either accepted or rejected in their entirety.

26. A method in accordance with claim 23, wherein said clearing of said demand side bids restricted by the quantity rule comprises:
rejecting a bid that has a bid price less than a market clearing price such that capacity corresponding to the bid is not purchased;
accepting a bid that has a bid price greater than or equal to the market clearing price such that additional demand is required; and
wherein each of said bids restricted by the quantity rule are considered lumpy such that they are either accepted or rejected in their entirety.

27. A method in accordance with claim 22, wherein the market clearing post processing further comprises:
pro-rating tied rationale bids and offers, wherein:
a ratio of an awarded quantity to a size of the bid or offer is equal for all tied bids or offers in the same zone; and
a total difference between the ratios of any two connected zones that have the same market clearing prices must be in a minimum level.

28. A method in accordance with claim 1, wherein selecting of the lumpy offers and price levels comprises:
ranking all lumpy offers within each zone by price;
removing all lumpy offers having a price higher than a price set by the zonal price ceiling;
adding a price level between any two adjacent lumpy blocks with different offer prices along the ranking;
setting the price level to a higher price of the prices for the two adjacent lumpy blocks; and
adding the zonal price ceiling price to the ranking to form a price-block list.

29. A method in accordance with claim 28, wherein the generating of the at least one feasible price/quantity combination comprises:
locating a plurality of supply blocks from the price-block list that have a highest offer price cleared in the initial bid cost minimization problem;
setting a priority of the located blocks to a high priority in order of price;
assigning the priority of each element in the price-block list according to a rank difference between each block and the block with the highest priority, a highest assigned priority corresponding to a smallest difference;
setting a priority level, starting from the highest priority;
selecting an element from the price-block list according to its priority to form a price/quantity combination;
wherein the priority of the element selected is great than or equal to the set priority level.

30. A method for clearing a forward capacity auction, comprising:
selecting a limited number of lumpy bids and offers received in the auction;
generating a plurality of feasible price/quantity combinations for the selected bids and offers;
determining a minimum consumer payment from said plurality of feasible price/quantity combinations; and
obtaining a market clearing solution based on said minimum consumer payment.

31. System for clearing a forward capacity auction, comprising:
means for selecting a limited number of lumpy bids and offers received in the auction;
means for generating a plurality of feasible price/quantity combinations for the selected bids and offers;
means for determining a minimum consumer payment from said plurality of feasible price/quantity combinations; and
means for obtaining a market clearing solution based on said minimum consumer payment.
